(19) United States
(12) Patent Application Publication
(10) Pub. No.: US 2026/0370598 A1
(43) Pub. Date: Nov. 19, 2026

(54) MODELING MULTIPATH TCP OVER HETEROGENEOUS WiFi AND 5G NETWORKS

(71) Applicant: Mitsubishi Electric Research Laboratories, Inc., Cambridge, MA (US)

(72) Inventors: Jianlin Guo, Newton, MA (US); Kieran Parsons, Gloucester, MA (US); Pu Wang, Cambridge, MA (US); Philip Orlik, Cambridge, MA (US)

(73) Assignee: Mitsubishi Electric Research Laboratories, Inc., Cambridge, MA (US)

(21) Appl. No.: 19/209,207

(22) Filed: May 15, 2025

(51) Int. Cl. H04L 47/12; H04L 69/163

(52) U.S. Cl. CPC H04L 47/12; H04L 69/163

(57) ABSTRACT

A node device of a multi-hop heterogeneous Wi-Fi and 5G network supports simultaneous delivery of data packets over Multipath TCP (MPTCP) paths. The node device executes a 5-State congestion control algorithm to control congestion on a MPTCP path based on path properties such as round trip time, path bandwidth and path loss. A Markov chain model is provided for Wi-Fi (IEEE 802.11) CSMA/CA function to compute round trip time on a MPTCP path. Based on the round trip time and adaptive congestion control window computed, data delivery is scheduled according to a loss-aware path scheduling method. The node device includes a transceiver configured to communicate data and other packets in the heterogeneous network, a memory configured to store computer executable programs including paths of the node device, round trip times for the paths and path information, and a processor configured to perform steps of the computer executable programs.

### FIELD OF THE INVENTION

This disclosure relates generally to transportation of data in wireless communications networks, and particularly to reliable transportation of data over multiple paths in heterogeneous Wi-Fi and 5G networks.

### BACKGROUND

With the growing demand for high-performance wireless communication, next-generation communication networks are increasingly built using heterogeneous technologies such as IEEE 802.11 Wi-Fi and the fifth generation (5G) networks. As network environments become more complex and diverse, the ability to efficiently manage data transmission across multiple communication interfaces is essential for improved network reliability, optimizing bandwidth, and improving overall network performance. Wireless networks rely on decentralized communication models where devices transmit and relay data dynamically. The default transport protocol for multipath communication systems is the Multipath Transmission Control Protocol also known as Multipath TCP (MPTCP), which extends the conventional Transmission Control Protocol (TCP) to support multiple transport paths for a single connection. Modern devices are often equipped with multiple communication interfaces, allowing them to connect to both Wi-Fi and 5G networks simultaneously. As a result, managing data transmission efficiently across the heterogeneous paths becomes critical for reliable connectivity and optimal use of network resources.

Accordingly, it is desirable to provide efficient multipath transport technologies to reliably deliver application data over multiple paths in heterogeneous wireless Wi-fi and 5G networks.

### SUMMARY

Various example embodiments are directed towards improving data transmission reliability in heterogeneous wireless Wi-Fi and 5G networks using principles of multipath communication. Some embodiments are directed towards adapting Multipath TCP for multi-hop heterogeneous wireless networks such as those based on career sense multiple access with collision avoidance (CSMA/CA). In this regard, some embodiments provide an adaptive congestion control mechanism that is a 5-State NewReno algorithm. The 5-State NewReno algorithm enhances the standard 4-State NewReno algorithm for MPTCP over multi-hop wireless networks by adding a new congestion window (cwnd) relaxation (CR) state, which allows the cwnd i.) remains unchanged under no packet loss condition, or ii.) decreases under no packet loss condition. In the CR state, congestion window (cwnd) is adaptively updated instead of deterministic increase or decrease like in conventional NewReno states. Some embodiments are also directed towards computing the round trip time (RTT) for data transmission over heterogeneous Wi-Fi and 5G networks. In this regard, some embodiments utilize the TCP Data and TCP ACK packets for the RTT computation and determine the random queuing time at a Wi-Fi node and a 5G node and determine random backoff time at a Wi-Fi node. Some embodiments also provide congestion control for data transmission in heterogeneous Wi-Fi and 5G networks by modelling full function Wi-Fi CSMA/CA as a Markov chain model.

It is a realization of several embodiments that as the number of wireless devices supporting multiple communication interfaces increases, connection redundancy may be used for efficient bandwidth utilization and network quality of service (QoS) improvement. The connection redundancy provides an opportunity to improve network performance, especially for multi-hop wireless networks. Accordingly, some embodiments are based on the recognition that network technologies should adapt to emerging multi-interface devices to improve network performance, especially for multi-hop wireless networks. Some embodiments are based on another realization that the devices in carrier sense multiple access with collision avoidance (CSMA/CA) based wireless networks typically form mesh topology. Accordingly, multiple communication paths can also be established between network nodes. Some embodiments enable the simultaneous use of the multipaths for communication.

Multipath TCP (MPTCP) specified in IETF RFC 8684 is the default multipath transport protocol designed for advanced communication networks with multi-interface devices to allow the simultaneous use of multiple communication interfaces for reliable data delivery. Some embodiments are based on the realization that MPTCP leads to increase in network throughput, improve communication reliability, and reduces network latency via the simultaneous use of multiple paths established using multiple communication interfaces. As a result, managing data transmission efficiently across the heterogeneous Multipath TCP (MPTCP) paths is essential for reliable connectivity and optimal use of network resources.

However, some embodiments also recognize that over CSMA/CA based wireless networks such as Wi-Fi, MPTCP faces challenges, in which random backoff delay incurs great difficulties for round trip time (RTT) computation and path scheduling. Congestion control and path scheduling are critical aspects of MPTCP for achieving high network efficiency. Conventionally, the standard 4-State NewReno algorithm specified in IETF RFC 6582 is a default congestion controller for MPTCP while the minimal RTT (MinRTT) is the default MPTCP scheduler. However, it is a realization that the key issue for MPTCP is the head of line (HoL) blocking caused by out-of-order packet arriving due to path heterogeneity such as RTT, path length, and link quality. In addition, in wireless IoT networks such as smart meter networks, there is no dedicated router. IoT nodes need to deliver their own data and relay data for other nodes if necessary. Compared to dedicated routers, IoT nodes have less resources and are less capable, which can lead to buffer overflow or load congestion. As a result, the application of MPTCP in wireless IoT networks is more challenging than that in conventional router-based computer networks. Towards this end, some embodiments are directed towards adapting MPTCP for data centric networks and multi-hop heterogeneous wireless networks by providing a 5-state adaptive congestion control mechanism for delivering application data from data nodes to data centers over multiple paths in heterogeneous Wi-Fi and 5G networks.

Various example embodiments are also directed towards forming heterogeneous wireless networks using data centers, mixed Wi-Fi data nodes and multi-interface data nodes which support both Wi-Fi and 5G communication interfaces. The data centers serve as multi-interface nodes and a Wi-Fi node may communicate with data centers, neighboring Wi-Fi nodes and multi-interface nodes via Wi-Fi interface, where a multi-interface node may communicate with neighboring Wi-Fi nodes via Wi-Fi communication interface and with data centers and 5G base stations (BSs) via 5G communication interface.

Some embodiments of the disclosure are based on recognition that a multi-interface node may either communicate with a data center directly or connects to a data center via base station network, where the operation of base station network is managed by network infrastructure. Accordingly, the base station network may be conceptually viewed as one base station node.

Some embodiments recognize that the nodes in a CSMA/CA based wireless networks form a mesh topology in which a node may have physical connectivity with many neighboring nodes. As a result, a node can build many paths to a data center. However, it is impractical to build too many paths. Accordingly, various embodiments of the disclosure define a threshold NPₜ to limit the number of paths from a data node to a data center.

Some embodiments are based on recognition that MPTCP scheduling requires round trip time (RTT), which depends on random queuing time, random backoff time, and other fixed times over heterogeneous Wi-Fi and 5G paths. Accordingly, the random queuing time and random backoff time is computed. To that end, some embodiments of the disclosure apply the well-known M/M/1/K queue to compute the random queuing time.

Some embodiments of the disclosure are based on recognition that the random backoff time in CSMA/CA based wireless networks depends on the CSMA/CA mechanism being used and different CSMA/CA mechanisms are defined in different communication technologies. For example, the CSMA/CA mechanisms in IEEE 802.11 standard, i.e., Wi-Fi, and IEEE 802.15.4 standard are quite different-IEEE 802.15.4 CSMA/CA does not sense channel in backoff time slots and does not suspend backoff counter while on the other hand, IEEE 802.11 CSMA/CA senses channel in each backoff time slot and suspends backoff counter if the channel is detected to be busy. In addition, to transmit a packet, IEEE 802.15.4 CSMA/CA performs random backoff no matter how long the channel has been idle, on the other hand, IEEE 802.11 CSMA/CA is used in the mandatory Distributed Coordination Function (DCF) mechanism, which allows immediate transmission if the channel is idle for more than DCF Interframe Spacing (DIFS) time.

Accordingly, some embodiments realize that the random backoff time computation in IEEE 802.11 (Wi-Fi) based networks is different from that in IEEE 802.15.4 based networks. To that end, some embodiments of the disclosure model the full-function Wi-Fi CSMA/CA as a Markov chain, which is applied to compute the random backoff time in Wi-Fi networks.

Accordingly, various embodiments of the disclosure provide a RTT computation method over heterogeneous paths consisting of Wi-Fi nodes and 5G nodes, wherein the time a TCP packet consumed at a Wi-Fi node depends on whether the packet is transmitted via immediate channel access or backoff process, wherein the time a TCP packet spent at a 5G does not involve channel access delay. Various embodiments are based on recognition that packet loss may occur in wireless networks and MPTCP scheduling must ensure TCP packets transmitted over multiple paths arrive at destination in order.

To that end, various embodiments provide a loss-aware path scheduling method which not only applies the RTT but also uses packet loss and link bandwidth over multiple MPTCP paths to ensure the packets arrive at a data center in order.

Some embodiments recognize that congestion control is critical for MPTCP. Although there are different congestion control methods for MPTCP, the NewReno algorithm specified in IETF RFC 6582 is a default congestion control method for TCP, wherein the standard NewReno algorithm is a 4-State algorithm in which congestion window (cwnd) size monotonically increases under no packet loss condition until it reaches the maximum value cwndₘₐₓ. This monotonic increase mechanism of the cwnd may waste network resources and therefore is not efficient. To that end, some embodiments of the disclosure provide a 5-State adaptive NewReno congestion control algorithm that allows the cwnd to maintain its current value or even decrease its value under no packet loss condition. Accordingly, some embodiments of the disclosure model 5-State congestion control algorithm as a Markov chain to compute the expected cwnd value for heterogeneous Wi-Fi and 5G paths.

In order to achieve the aforementioned advantages and objectives, some embodiments provide adaptive MPTCP technologies to fit MPTCP protocol in heterogeneous Wi-Fi and 5G networks.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A is a schematic illustrating a system for modeling multipath TCP over heterogenous Wi-Fi and 5G networks, according to some embodiments;

FIG. 1B depicts a model flowchart illustrating the modeling multipath TCP over heterogenous Wi-Fi and 5G networks, according to some embodiments;

FIG. 2A is a schematic illustrating a heterogeneous Wi-Fi and 5G network, according to some embodiments;

FIG. 2B illustrates an embodiment of routing topology with Multipath TCP (MPTCP) paths for data nodes in a heterogeneous wireless network illustrated in FIG. 2A, according to some embodiments;

FIG. 3 depicts a network protocol stack with Multipath TCP (MPTCP) protocol, according to some embodiments;

FIG. 4 depicts a flowchart of the standard 4-State NewReno congestion control algorithm, according to some embodiments;

FIG. 5 depicts a timing diagram illustrating the necessity to maintain congestion window under no packet loss condition, according to some embodiments;

FIG. 6 depicts a timing diagram illustrating the necessity to reduce congestion window under no packet loss condition, according to some embodiments;

FIG. 7 depicts a flowchart of 5-State NewReno congestion control algorithm, according to some embodiments;

FIG. 8 depicts the Markov chain model of the state transition in the 5-State NewReno congestion control algorithm, according to some embodiments;

FIG. 9 illustrates the Wi-Fi CSMA/CA function, according to some embodiments;

FIG. 10 depicts the Markov chain model of Wi-Fi CSMA/CA function, according to some embodiments;

FIG. 11 depicts a round trip time (RTT) computation over a multi-hop MPTCP path in multi-hop wireless networks using TCP data packet and TCP acknowledgement (ACK) packet, according to some embodiments;

FIG. 12 depicts a hop-to-hop RTT computation over a multi-hop MPTCP path in multi-hop wireless networks, according to some embodiments;

FIG. 13 depicts an MPTCP path scheduling from a data node D to a data center (DC) over K paths, according to some embodiments;

FIG. 14 depicts a flow diagram illustrating a use case for modeling MPTCP over heterogenous Wi-Fi and 5G networks, according to some embodiments; and

FIG. 15 illustrates some components of a system for modeling MPTCP over heterogenous Wi-Fi and 5G networks, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a FIG. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

### Overview

Smartphones and laptop computers are typical multi-interface devices. Recently, wireless IoT devices such as smart meters support multiple communications and perform complexed tasks, e.g., current generation smart meters support one communication interface and collect regular metering data only, on the other hand, next generation meters may support multiple communication interfaces such as Wi-Fi (IEEE 802.11) and 5G, collect regular metering data and sense power supply information. The power supply information is critical for smart grid to make predictive maintenance and diagnose the cause of the abnormal events such as power outage and therefore, needs to be reliably delivered. In addition, there are various data such as software/firmware distribution and security/safety monitoring data in modern application networks also require reliable delivery. There are various wireless communication technologies including Wi-Fi (IEEE 802.11) and 5G communication technologies which are used in wireless IoT networks. Accordingly, it is desirable to provide MPTCP technologies for efficient and reliable communications and data delivery in heterogeneous Wi-Fi and 5G networks.

Multipath TCP (MPTCP) specified in IETF RFC 8684 is the default multipath transport protocol that allows the simultaneous use of multiple communication paths for reliable data delivery. MPTCP has achieved success in computer networks, and it can increase network throughput, improve communication reliability, and reduce network latency via the simultaneous use of multiple paths established using multiple communication interfaces.

Despite the success of MPTCP in computer networks, its deployment over wireless networks is not well explored, especially over CSMA/CA based wireless networks, in which random backoff delay incurs great challenges for round trip time (RTT) computation and path scheduling. One of the challenges about MPTCP is the head of line (HoL) blocking caused by out-of-order packet arriving due to path heterogeneity such as RTT, path length, and link quality. In addition, in wireless IoT networks, there is no dedicated router. IoT nodes need to play router's role. Compared to dedicated routers, IoT nodes have less resources and are less capable, which can lead to buffer overflow or load congestion. As a result, the application of MPTCP in wireless IoT networks is more challenging than that in conventional router-based computer networks.

As the number of wireless devices supporting multiple communication interfaces, referred to as multi-interface, increases, multipath technologies have been developed to communicate over multiple paths to improve network performance. Furthermore, devices in carrier sense multiple access with collision avoidance (CSMA/CA) based wireless networks typically form mesh topology, in which multiple communication paths may also be established without requiring multiple communication interfaces.

Additionally, some embodiments realize that Wi-Fi CSMA/CA operates on a listen-before-talk paradigm, where transmission is deferred when the channel is sensed busy. This introduces random backoff time and increases overall latency, making Wi-Fi paths less predictable compared to 5G. In dynamic network environments, such as in mobile or dense IoT deployments, this unpredictability introduces inefficiencies in MPTCP's default RTT-based path scheduling, causing frequent HoL blocking and suboptimal load balancing.

Conventional methods for MPTCP assumes the presence of backbone routers and stable routing infrastructure, which may not be always present in wireless IoT scenarios. In the cases, devices may cooperatively forward packets, forming ad hoc mesh topologies. The decentralized routing behavior, coupled with wireless-specific impairments such as interference and signal fading, complicates the maintenance of path consistency and impairs MPTCP's ability to reliably aggregate bandwidth across multiple interfaces or paths.

To address these challenges, some embodiments provide an optimized multipath transport mechanism tailored for heterogeneous Wi-Fi and 5G networks. A 5-State congestion control algorithm and a loss-aware multipath scheduling method are introduced to enhance the performance of multipath transport over heterogeneous wireless networks. The 5-State congestion control algorithm presents a congestion window (cwnd) relaxation (CR) state to adapt the cwnd size for no packet loss case, in which cwnd remains or decreases. The loss-aware multipath scheduling method schedules data packet transmission across multiple paths by incorporating round trip time (RTT), cwnd, and packet loss rate. Various embodiments have several practical applications across diverse industries, including smart grid telemetry, industrial automation, intelligent transportation systems, smart city and smart infrastructures, where real-time, reliable, and scalable data transmission over heterogeneous wireless networks is essential.

### System and Method for Modeling Multipath TCP Over Heterogenous Wi-Fi and 5G Networks

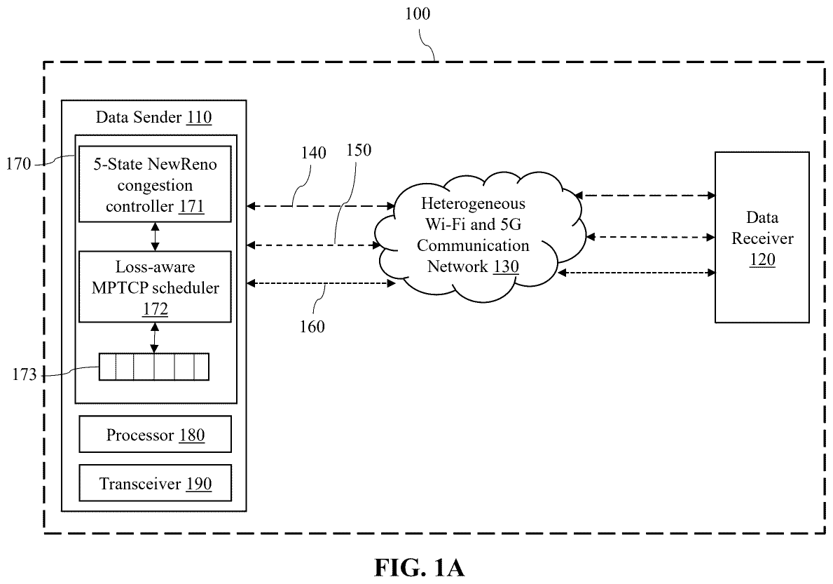

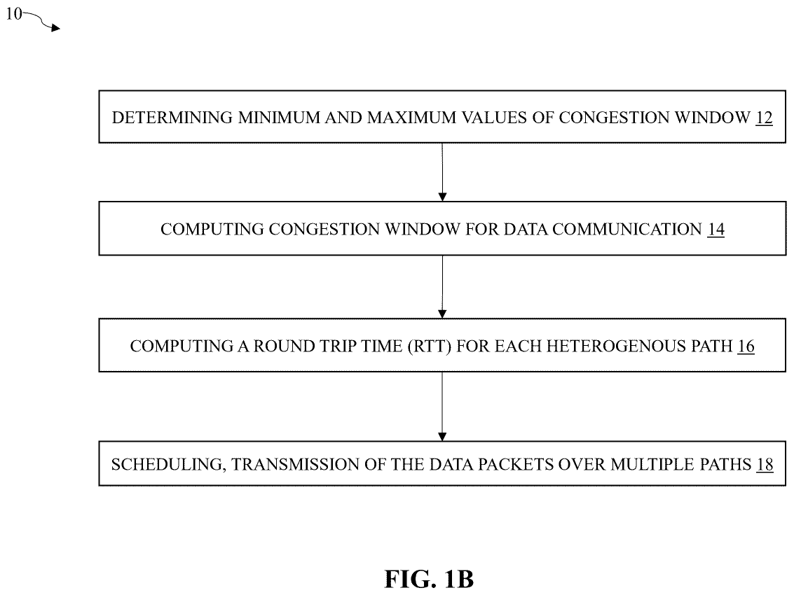

FIG. 1A is a schematic illustrating a system 100 for modeling multipath TCP over heterogenous Wi-Fi and 5G networks, according to some embodiments. The system 100 comprises a data sender 110, a data receiver 120, and a heterogeneous Wi-Fi and 5G communication network 130, configured to enable the reliable delivery of data packets and acknowledgement messages across diverse communication paths. The system 100 is designed to operate within modern multi-interface device environments where communication paths differ significantly in speed, quality, and latency and the CSMA/CA based network environments where devices form mesh topology.

The data sender 110 is a transmitting device such as a smartphone, smart meter, or computing node equipped with one or more communication interfaces. The data sender 110 is configured to transmit data toward the data receiver 120 using multiple network paths such as high-speed path 140, medium speed path 150, and low speed path 160. The paths may consist of Wi-Fi and 5G links with varying throughput and latency characteristics. The data sender 110 includes a processor 180, and a transceiver 190, which collaboratively enable multipath transmission.

The data stream 173 represents a continuous sequence of one or more data packets scheduled for multipath transmission across a heterogeneous wireless network. Each data packet of one or more data packets within the data stream 173 contains payload data, protocol headers, and metadata used for tracking the data packet's sequence, retransmission status, and intended transmission path. The data stream 173 may originate from various applications executed by the data sender 110, including metering data, control commands, firmware updates, and event logs. Depending on application priority and quality-of-service (QoS) constraints, different packets within the data stream 173 may require low latency, high reliability, or high bandwidth.

The one or more data packets from the data stream 173 are dynamically distributed across multiple transmission paths (e.g., high-speed path 140, medium-speed path 150, and low-speed path 160) by the loss-aware MPTCP scheduler 172. The distribution is based on real-time network conditions, such as per-path round trip time (RTT), loss rate, and congestion window size. The processor 180 maintains sequencing information for proper reassembly of one or more data packets at the data receiver 120. If certain data packets are lost or excessively delayed, the retransmission logic, under the loss-aware MPTCP scheduler 172, ensures the one or more data packets are resent over alternate paths. The 5-State NewReno congestion controller 171 controls the number of data packets that can be scheduled in a scheduling round. The flexible structure of data stream 173 enables MPTCP to maximize throughput, reduce head-of-line blocking, and maintain application-level delivery guarantees under diverse network conditions.

The processor 180, a central computational unit within the data sender 110 of the MPTCP data transmission network system 100, is responsible for executing the core control logic and managing end-to-end data flow across multiple network paths. It performs key computational tasks to ensure reliable, efficient, and congestion-aware transmission of data in heterogeneous communication environments comprising Wi-Fi and 5G networks. The processor 180 processes streams of data packets 173 and determines optimal transmission strategies based on real-time path metrics such as round trip times (RTTs), congestion window (cwnd), and packet loss rates. Upon receiving updated path information and acknowledgements from the data receiver 120, the processor 180 analyzes per-path performance to dynamically assign data packets to the most suitable communication paths including the high-speed path 140, middle-speed path 150, or slow-speed path 160 while maintaining load balance and maximizing throughput. The processor 180 executes the enhanced 5-State NewReno Congestion Controller 171 and operates the Loss-Aware MPTCP Scheduler 172, which prioritizes the delivery of data packets over the loss-tolerant paths and may temporarily suppresses scheduling on paths experiencing excessive packet loss or unstable signal conditions.

The 5-State NewReno Congestion Controller 171 tailored to dynamically respond to wireless path conditions through five defined states. In each state, the processor 180 adjusts the congestion window size, retransmission timers, and in-flight packet count in response to both loss-based and delay-based congestion indicators received through acknowledgements or inferred via packet delay variations. The 5-State NewReno congestion controller 171 introduces a new state called congestion window (cwnd) relaxation (CR) where the 5-State NewReno congestion controller 171 addresses a unique but frequent case in multipath scheduling—where no packet is lost, yet network congestion controller suppresses scheduling on paths with excessively increased congestion window sizes. In this state, the congestion window (cwnd) is either held constant or adaptively reduced to avoid idle paths and improve throughput.

The main components of MPTCP protocol include (1) path manager, (2) path scheduler and (3) congestion controller. The path manager is responsible for path construction and management. The path scheduler distributes TCP data flows over multiple paths. The congestion controller manages data amount over a path to avoid congestion. The conventional MPTCP schedulers include default minimal round trip time (MinRTT) scheduler in which the paths are scheduled based on RTT with the smaller RTT paths having higher priorities, Round Robin scheduler in which paths are scheduled in a round robin fashion, Redundant scheduler in which data are redundantly sent on all available paths, and other schedulers.

The loss-aware MPTCP scheduler 172 is a dynamic packet scheduling module executed by processor 180, responsible for selecting appropriate paths for each outgoing data packet in the data stream 173. The loss-aware MPTCP scheduler 172 operates on the principle of loss differentiation and adaptive path selection prioritizing on empirical loss patterns and path volatility. By evaluating per-subflow loss rates and packet delivery success, the loss-aware MPTCP scheduler 172 identifies paths with higher reliability under current network condition. When the loss-aware MPTCP scheduler 172 detects a spike in data packet loss or increased jitter on a particular path, the loss-aware MPTCP scheduler 172 may reduce traffic allocation to that path temporarily, rerouting data packets over more stable paths. The loss-aware MPTCP scheduler 172 also cooperates with the 5-State NewReno congestion controller 171 to interpret feedback such as duplicate ACKs and selective acknowledgements, refining the path selection strategy accordingly.

The transceiver 190 acts as the wireless communication interface for data sender 110, responsible for physically transmitting and receiving data and control packets over the heterogeneous Wi-Fi and 5G networks. The transceiver 190 is capable of interfacing with multiple network interfaces concurrently and adheres to the respective PHY and MAC layer standards of each communication technology. The transceiver 190 supports bidirectional communication transmitting outgoing data packets of the data stream 173 towards the data receiver 120, and receiving acknowledgements and control messages in return. The transceiver 190 works closely with the processor 180 for link-level reliability, implements adaptive power control to optimize energy consumption, and supports features such as retransmission of lost packets.

The heterogeneous Wi-Fi and 5G communication network 130 facilitate seamless data exchange between data senders 110 and the data receiver 120. The heterogenous Wi-fi and 5G communication network 130 may be implemented using various wireless technologies to accommodate diverse operational environments and device mobility. Wireless networks, including Wi-Fi, 5G, Zigbee, LoRaWAN, and satellite communication, provide flexibility and scalability for mobile or remote operations. The network 130 may include hardware components such as modems, Wi-Fi transceivers, or other communication devices responsible for establishing a connection to the wider network, enabling data transmission. Software within the heterogenous Wi-fi and 5G communication network 130 may be responsible for packetizing and de-packetizing data for network communication or managing communications over a cloud-based platform. In some embodiments, the heterogenous Wi-fi and 5G communication network 130 combines control and forwarding functions on the same physical hardware, while in other cases, these functions might be split, with the control functions managed by external network devices in configurations such as software-defined networking (SDN).

The data receiver 120 is the receiving endpoint of the MPTCP data transmission system 100. The data receiver 120 aggregates incoming data packets arriving via multiple paths and sends back acknowledgments to the respective data sender 110. The data receiver 120 may be a server, application gateway, or central controller in the heterogenous Wi-fi and 5G communication network 130. The data receiver 120 is configured to support MPTCP reordering buffers and state tracking to handle out-of-order packet arrivals, a common phenomenon in multipath networks. Additionally, the data receiver 120 interacts with MPTCP-specific options in TCP headers to provide real-time feedback such as ACKs with per-sub flow information, helping data sender 110 update its congestion and scheduling models accordingly.

FIG. 1B depicts a flowchart 10 illustrating the modeling multipath TCP over heterogenous Wi-Fi and 5G networks, according to some embodiments. At step 12, the 5-State congestion controller 171 determines minimum and maximum values of congestion window for each path. At step 14, the 5-State congestion controller 171 computes a value of congestion window for each heterogeneous path for data communications. At step 16, the loss-aware MPTCP scheduler 172 computes a round trip time (RTT) for each heterogeneous path. At step 18, the loss-aware MPTCP scheduler 172 schedules and transmits data packets across multiple MPTCP paths based on the RTT and the congestion window in the manner described with reference to several embodiments in this disclosure.

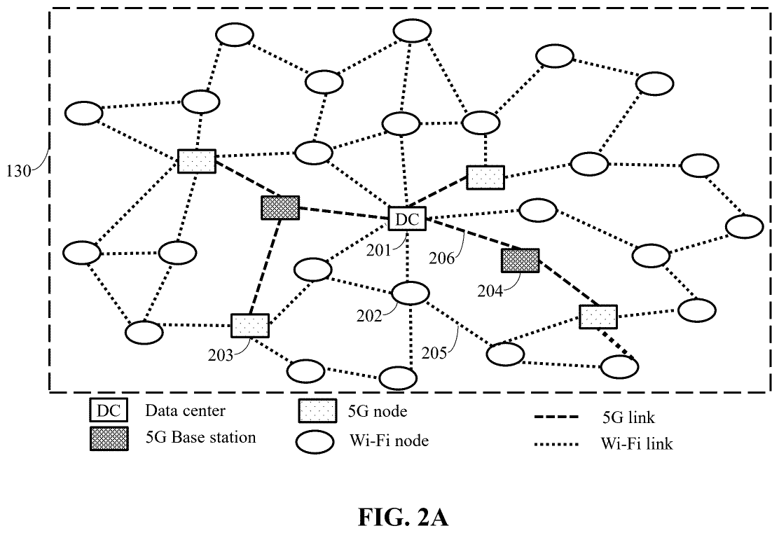

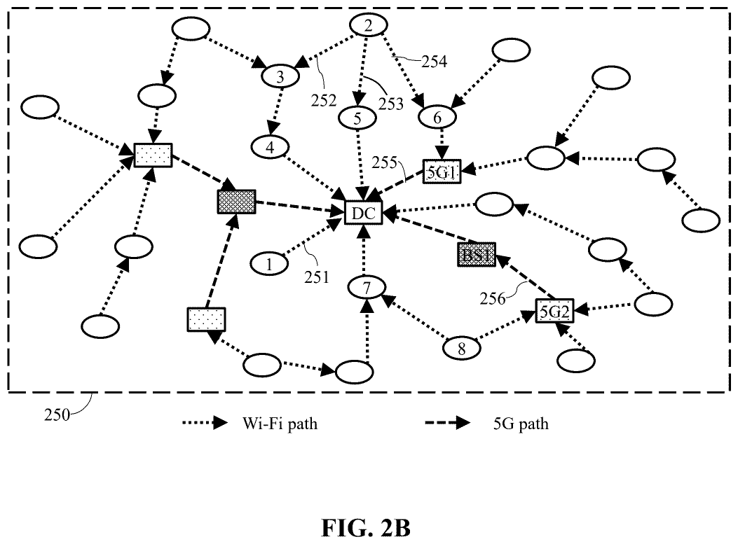

FIG. 2A is a schematic illustrating a heterogeneous Wi-Fi and 5G network 130, according to some embodiments. The heterogeneous Wi-Fi and 5G network 130 showcase a distributed mesh topology composed of diverse node types Wi-Fi nodes 202, 5G nodes 203, 5G base stations 204, and a central data center 201 connected via distinct communication links. The communication links include Wi-Fi links 205, represented as dotted lines, and 5G links 206, shown as dashed lines. The heterogeneous Wi-Fi and 5G network 130 architecture facilitates the transmission of data from multiple sender nodes to a central receiver while ensuring bidirectional control message exchange across the entire communication framework.

The core of the heterogeneous Wi-Fi and 5G network 130 comprises of the data center 201, which serves as the centralized data receiver and processing unit. The data center 201 is equipped with dual communication interfaces Wi-Fi and 5G enabling the data center 201 to receive incoming data packets across heterogeneous paths. Beyond data reception, the data center 201 may be responsible for aggregating traffic, executing application-level services, managing congestion responses, and issuing downstream commands or acknowledgments to sending nodes. This dual-interface capability allows the data center 201 to seamlessly integrate with both traditional Wi-Fi infrastructures and modern cellular (5G) systems.

The heterogeneous Wi-Fi and 5G network 130 comprise of two primary types of data senders including Wi-Fi nodes 202 and 5G nodes 203. The Wi-Fi nodes 202, also referred to as single-interface nodes, support only Wi-Fi communication protocols. The Wi-fi nodes 202 are typically embedded within environments where low-cost, short-range, and energy-efficient communication are essential, such as smart homes, wearable IoT devices, or environmental monitoring systems. Due to their limited communication capability, Wi-Fi nodes 202 rely heavily on multi-hop forwarding through neighboring nodes to reach the data center 201, especially when located beyond direct transmission range.

The 5G nodes 203, also referred as multi-interface nodes, are advanced and support both Wi-Fi and 5G communication interfaces. The 5G nodes 203 operate as data nodes or flexible communication gateways or relays within the heterogeneous Wi-Fi and 5G network 130. Positioned strategically, 5G nodes 203 may serve as intermediaries between remote Wi-Fi nodes 202 and the central data center 201. The dual-interface design enables them to switch between or concurrently use Wi-Fi and 5G interfaces based on current network performance, congestion levels, or transmission priority. For instance, under high-load scenarios, a 5G node 203 may offload data to the 5G network to reduce latency and bypass congested Wi-Fi paths.

The 5G base stations 204 are stationary infrastructure units providing centralized 5G access to the mobile and multi-interface nodes within the heterogeneous Wi-Fi and 5G network 130. The 5G base stations 204 serve as anchor points for 5G links 206, enabling high-speed, low-latency communication between 5G nodes 203 and the data center 201. The 5G base stations 204 operate across wider geographic areas compared to Wi-Fi nodes and provide services like mobility management, handover coordination, and secure access control for 5G nodes 203.

Wi-Fi links 205 connect any two Wi-Fi-capable nodes either Wi-Fi nodes 202, 5G nodes 203 (via Wi-Fi interface), or the data center 201. The Wi-fi links 205 are used for transmitting data packets such as sensor readings, status reports, or application-layer messages. Wi-Fi links 205 are best suited for medium-throughput, short-range communication, and may be used for routine or delay-tolerant transmissions. Conversely, 5G links 206 are established between 5G nodes 203 and 5G base stations 204, or directly between 5G nodes 203 and the data center 201. The 5G links 206 support high-bandwidth, low-latency traffic, and are preferred for time-critical or high-priority data, such as real-time control signals, video streams, or alert responses.

The heterogeneous Wi-Fi and 5G network 130 support bidirectional communication, where data packets primarily flow upstream from sender nodes (Wi-Fi or 5G) to the data center 201, while control messages such as acknowledgments (ACKs), configuration updates, or retransmission requests may flow downstream. For instance, in a smart transportation system, Wi-Fi nodes on buses may periodically send location and occupancy data to the data center through intermediate 5G nodes. When a high-priority event occurs, such as traffic congestion or accident detection, the 5G node may switch to a direct 5G path for real-time delivery. Simultaneously, the data center may issue control signals back to reroute buses or update roadside alerts via the same heterogeneous mesh.

In wireless mesh topology illustrated in FIG. 2A, there are numerous network paths which may be established between a data node and a data center. However, in practice, the longer paths are not preferable due to longer latency. Therefore, a threshold NPₜ can be defined to limit the number of paths from a data node to a data center. The definition of NPₜ depends on application requirements, node types and network topology.

FIG. 2B illustrates an embodiment of routing topology 250 with Multipath TCP (MPTCP) paths for data nodes in the heterogeneous Wi-Fi and 5G network illustrated in FIG. 2A, according to some embodiments. The routing topology 250 showcases how multiple parallel communication paths may be dynamically communicated from various data nodes to the central data center (DC), for efficient data transmission and resilience against link or node failures. In some embodiment, Wi-Fi node 1 establishes a direct 1-hop connection to the DC (path 251:1→DC), serving as minimal-hop, low-latency data delivery, often preferred when node proximity and signal strength are favorable. Such direct paths are ideal for delay-sensitive tasks or urgent control signaling.

Wi-Fi node 2 demonstrates the heterogeneous wireless network's 130 capability to utilize multiple alternate routes to the DC simultaneously, which is one of the advantages offered by MPTCP. The heterogeneous wireless network 130 forms three distinct paths: A 3-hop path using only Wi-Fi nodes (path 252: 2→3→4→DC), which reflects conventional multi-hop mesh behavior often observed in homogeneous wireless networks. A 2-hop Wi-Fi path (path 253: 2→5→DC), which is shorter and potentially efficient under certain network conditions such as reduced interference or congestion along intermediate nodes. A 3-hop hybrid path that includes both Wi-Fi and 5G nodes (path 254: 2→6→5G1→DC). This path is especially notable for its ability to switch from a local Wi-Fi domain to a high-capacity 5G uplink through 5G node 5G1, showcasing how the network can flexibly exploit heterogeneous connectivity.

5G node 5G1, which can serve as an intermediate node in path 254, also maintains its own 1-hop path to the DC (path 255: 5G1→DC). The path is a sub-segment of path 254 and illustrates how overlapping routes may be shared or reused by multiple source nodes. Such modular path design simplifies routing management and supports load balancing at the core level. At the edge of the heterogeneous wireless network 130, 5G node 5G2 establishes a 2-hop route (path 256: 5G2→BS1→DC), where BS1 functions as a base station bridging the outer 5G segment with the central infrastructure.

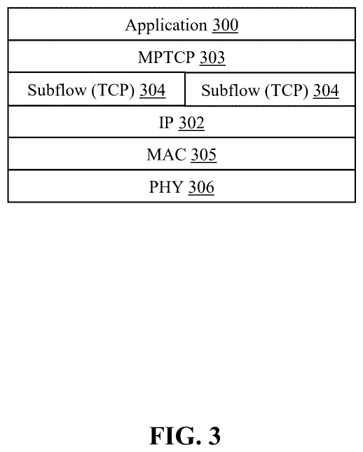

FIG. 3 depicts a network protocol stack with Multipath TCP (MPTCP) protocol, according to some embodiments. FIG. 3 includes an application layer 300, a MPTCP layer 303, an IP layer 302, an MAC layer 305 and an PHY layer 306. The application layer 300 represents the interface where end-user applications reside such as IoT control systems, video streaming platforms, or telemetry dashboards. The application layer 300 generates and consumes data and interacts with the transport layer through system-level sockets. Critically, with MPTCP in place, applications may benefit from multipath transmission without any modifications, as MPTCP is fully transparent to the application layer and mimics the behavior of a traditional TCP connection.

The MPTCP layer 303 provides a functionality which includes data scheduling, congestion control, and flow management across multiple underlying network paths. The MPTCP layer 303 is responsible for segmenting the application data stream and distributing the application data intelligently across multiple available connections, depending on network conditions such as latency, bandwidth availability, and congestion. Additionally, MPTCP layer 303 maintains backward compatibility to the application layer 300, an MPTCP connection is indistinguishable from a standard TCP connection, meaning that no modification is required at the application level to benefit from multipath capabilities.

The subflow layer 304 handles the creation and management of the multiple TCP subflows, each behaving like an independent traditional TCP connection. The TCP subflows are routed independently, often over different MPTCP paths. Each subflow may be passed to the IP layer 302. The IP layer is responsible for packet delivery across networks-assigning source and destination IP addresses and ensuring each packet reaches the correct endpoint. In the MPTCP context, the IP layer enables subflows to operate across different IP address pairs, facilitating multipath diversity. For example, one subflow may traverse a Wi-Fi IP address pair, while another may use a 5G IP address pair, leveraging parallel connections for increased reliability and throughput.

Supporting the IP layer is the MAC (Media Access Control) layer 305, which governs how data is framed and transmitted over the physical medium, including link access arbitration, error checking, and addressing. The MAC layer 305 ensures orderly access to shared media like wireless channels and handles local delivery over a specific link type (e.g., Wi-Fi or cellular). At the base, the PHY (Physical) layer 306 transmits raw bits over the physical medium using modulation, coding, and antenna technologies. The PHY layer 306 defines the hardware-level characteristics of the communication link and influences link reliability, speed, and signal coverage.

### Standard 4-State NewReno Congestion Control Algorithm

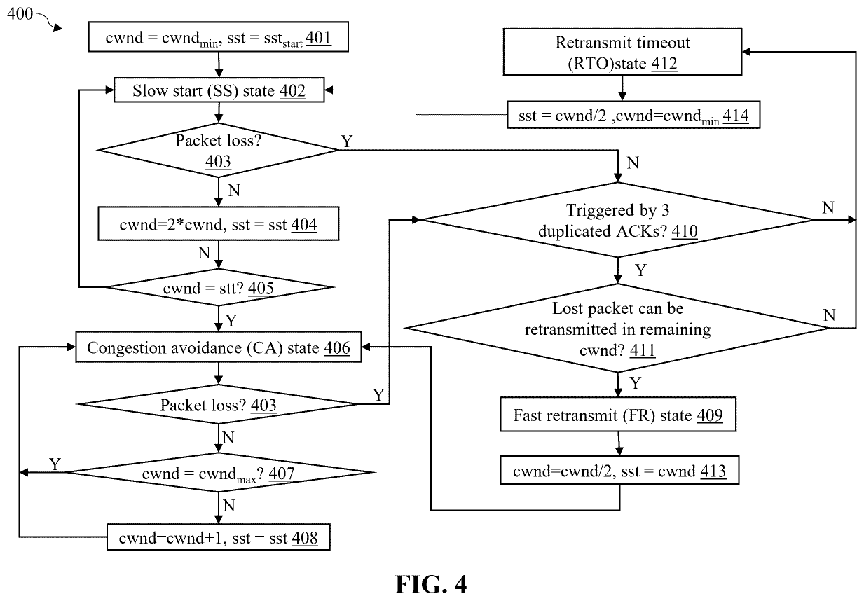

FIG. 4 depicts a flowchart of the standard 4-State NewReno congestion control algorithm 400, according to some embodiments. The standardized NewReno algorithm specified in IETF standard RFC 6582 is a widely used congestion controller for MPTCP. NewReno is a 4-State algorithm, where NewReno uses congestion window (cwnd), slow start threshold (sst) and receiver window (rwnd) to control traffic congestion. The cwnd limits the number of packets that can be transmitted over a path in a scheduling round and the rwnd indicates amount of data receiver is willing to accept. NewReno algorithm 400 initiates cwnd to cwndₘᵢₙ and sstₛₜₐᵣₜ to the largest advertised rwnd or a value based on network path 401. NewReno algorithm 400 then starts in slow start (SS) state 402. At the end of a scheduling round, NewReno algorithm 400 checks packet loss 403. If there is no packet loss in a scheduling round, cwnd is doubled for next scheduling round 404. If the doubled cwnd is less than stt, the NewReno algorithm 400 goes back to SS state 402 again. When cwnd reaches sst 405, the NewReno algorithm 400 transits to congestion avoidance (CA) state 406, in which if there is no packet loss 403 and cwnd is less than cwndₘₐₓ 407, the cwnd is incremented by one 408 in each scheduling round until cwnd reaches cwndₘₐₓ 407, where cwnd remains unchanged. In either SS state 402 or CA state 406, if packet loss occurs in a scheduling round, the NewReno algorithm 400 transits to fast retransmit (FR) state 409, if the loss is triggered by three duplicate ACKs 410 and the lost packets can be recovered within the remaining window cwndᵣₑₘ 411 or otherwise to retransmit timeout (RTO) state 412. If NewReno algorithm 400 transits to FR state, both sst and cwnd are set to cwnd/2 413. If NewReno algorithm 400 transits to RTO state, sst is first set to cwnd/2 and cwnd is set to cwndₘᵢₙ 414. For the simplicity, denote w as the cwnd. The state transition probabilities are given as:

$${p}_{SS} ( w ) = {p}_{CA} ( w ) = p ( 0 \vert w ) ,$$

$${p}_{RTO} ( w ) = \{ \begin{matrix}{\sum }_{i = 1}^{w - 3} p ( i \vert w ) ( 1 - {( 1 - l )}^{i} ) + {\sum }_{i = w - 2}^{w} p ( i \vert w ) , & w \geq 4 \\ 1 - p ( 0 \vert w ) , & w < 4\end{matrix}$$

$${p}_{FR} ( w ) = \{ \begin{matrix}1 - {p}_{RTO} - p ( 0 \vert w ) , & w \geq 4 \\ 0 , & w < 4\end{matrix}$$

where l is the packet loss probability and

$$p ( x \vert w ) = ( \begin{matrix}w \\ x\end{matrix} ) {{l}^{x} ( 1 - l )}^{w - x}$$

is the probability of x packet loss in w packets.

NewReno algorithm 400 was designed for computer networks with relatively stable network environment. Its cwnd update is deterministic. To adapt to dynamic wireless networks, the present disclosure enhances NewReno algorithm 400 by providing a new state.

In NewReno algorithm 400, cwnd increases under no packet loss conditions.

However, it is necessary to maintain or reduce cwnd even without packet loss. All TCP packets are considered as data frame at Wi-Fi MAC layer, indicating a Wi-Fi receiver will transmit a MAC layer ACK frame at Short Interframe Space (SIFS) time before forwarding the received TCP packet up to TCP/IP layers. Recall that Wi-Fi CSMA/CA enables an immediate channel access mechanism such that if channel is idle for more than DCF Interframe Space (DIFS) time, a Wi-Fi device can transmit frame immediately without random backoff. Denote as RTTₓ₋ₕ the round trip time (RTT) to transmit x packets over a h-hop Wi-Fi path and TP the time to transmit packet P. Assuming the Wi-Fi channel is idle and delayed TCP ACK mechanism is applied, i.e., one ACK for each scheduling round. Ignoring packet propagation time and TCP/IP layer packet processing time, following relations hold:

RTT₁₋₁=2DIFS+2SIFS+2T_{MAC ACK}+T_{TCP Data}+T_{TCP ACK},

RTT₁₋₂=2RTT₁₋₁,

RTT₂₋₁=RTT₁₋₁+DIFS+T_{TCP} Data+SIFS+T_{MAC ACK},

RTT₁₋₃=3RTT₁₋₁.

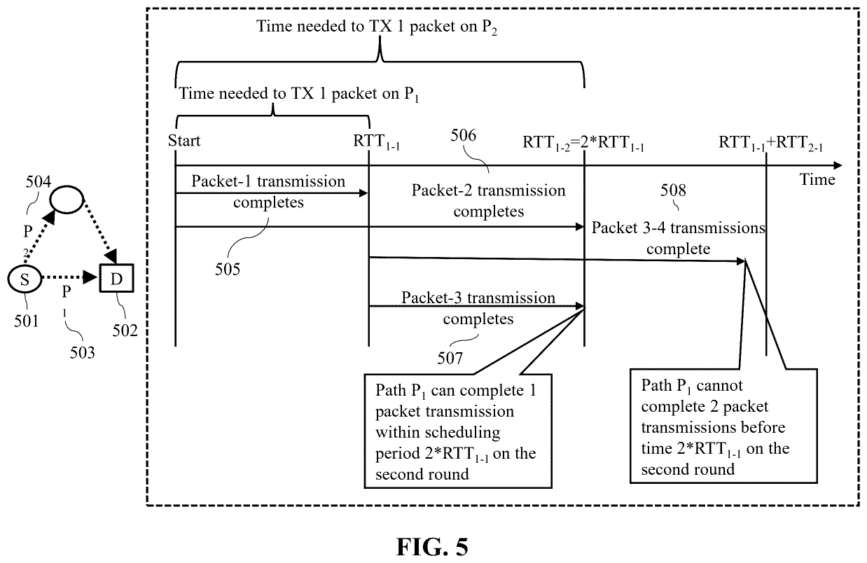

FIG. 5 depicts a timing diagram illustrating the necessity to maintain congestion window (cwnd) under no packet loss condition, according to some embodiments. Based on the above illustrated relations, FIG. 5 illustrates the necessity to maintain cwnd under no packet loss condition, where S is source node 501, D is destination node 502, path P₁ 503 is a 1-hop Wi-Fi path and path P₂ 504 is a 2-hop Wi-Fi path, these two paths do not interfere with each other and can be used simultaneously, e.g., by using two antennas for simultaneous transmissions. For MPTCP scheduling, RTT of the slower path is typically used as scheduling period. Accordingly, RTT₁₋₂ of path P₂ 504 is scheduling period. Assume cwnd₁=cwnd₂=1 initially, in the first scheduling round, packet-1 505 is sent on path P₁ 503 and packet-2 506 is sent on path P₂ 504. Path P₁ completes its first round at time RTT₁₋₁, cwnd₁ is then increased to 2 for the second round. However, path P₁503 cannot deliver 2 packets 508 within remaining RTT₁₋₁ time. As a result, path P₁ 503 is idle for the rest of RTT₁₋₁ time, which is a waste. As a result, only two packets are delivered within RTT₁₋₂ time period. Had cwnd₁ remained at 1, path P₁ 503 could deliver packet-3 507 in remaining RTT₁₋₁ time. Accordingly, three packets would be delivered within RTT₁₋₂ time period.

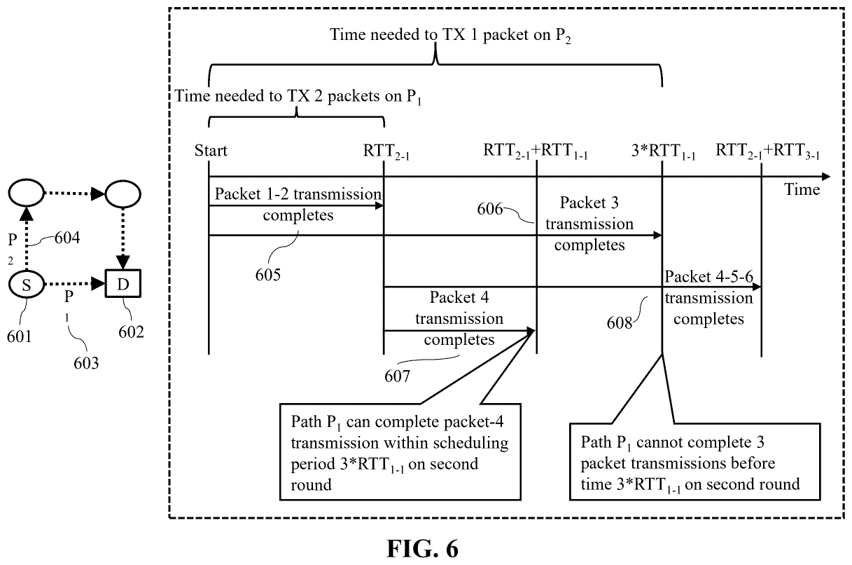

FIG. 6 depicts a timing diagram illustrating the necessity to reduce congestion window (cwnd) under no packet loss condition, according to some embodiments. FIG. 6 demonstrates the necessity to reduce cwnd under no packet loss condition, where S is source node 601, D is destination node 602, path P₁ 603 is a 1-hop Wi-Fi path and path P₂ 604 is a 3-hop Wi-Fi path, these two paths do not interfere with each other. Again, RTT₁₋₃ of path P₂ 604 is the scheduling period. Assume cwnd₁=2, cwnd₂=1 initially. In the first scheduling round, packet-1 and packet-2 605 are sent on path P₁ 603 and packet-3 606 is sent on path P₂ 604. Path P₁ completes its first round at time RTT₂₋₁, cwnd₁ is then increased to at least 3 for the second round. However, path P₁ cannot deliver 3 packets 608 within remaining RTT₁₋₁ time. As a result, path P₁ 603 is idle for the rest of RTT₁₋₁ time, which is a waste. As a result, only three packets are delivered within RTT₁₋₃ time period. Had cwnd₁ been reduced to 1 for the second round, path P₁ 603 could deliver packet-4 607 in remaining RTT₁₋₁ time. Accordingly, four packets would be delivered within RTT₁₋₃ time period.

To address this drawback, the present disclosure provides a new NewReno state named as congestion window (cwnd) relaxation (CR) for no packet loss case, in which sst remains and cwnd remains or decreases. Consider a path P, the state transition probability p_{CR} to a CR state depends on the length SP of the scheduling period, which is typically the RTT of the path P if path P is the slowest path or the RTT of the next slower path, and the remaining scheduling time SPᵣₑₘ, scheduling round r and the congestion window (cwnd) size w(r) on the r-th round. Let T(i) be the time spent on the i-th scheduling round (i=1, 2, . . . , r), then SPᵣₑₘ can be computed as SPᵣₑₘ=SP−(T(1)+T(2)+ . . . +T(r)). The probability that the (r+1)-th round transits to CR state is given by

P_{CR}(w(r))=p(0|w(r))p(T(1)+T(2)+ . . . +T(r+1)>SPᵣₑₘ|T(1)+T(2)+ . . . +T(r)<SPᵣₑₘ),

where T(r+1) can be computed as described in loss-aware scheduling section.

### 5-State NewReno Congestion Control Algorithm

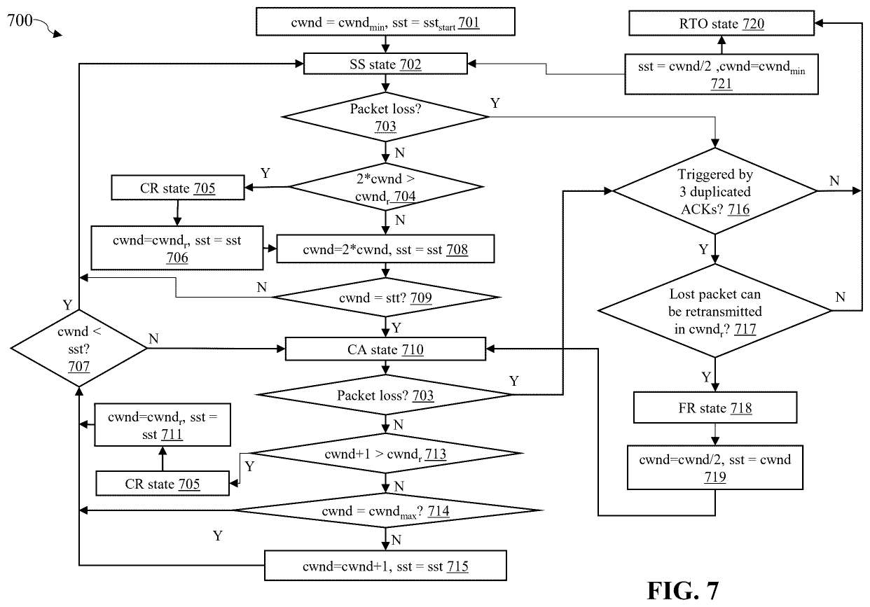

FIG. 7 depicts a flowchart of 5-State NewReno congestion control algorithm 700, according to some embodiments.

The flowchart of 5-State NewReno algorithm 700 can transit to CR state from either SS state or CA state. On a CR state, the 5-State NewReno algorithm can transit to either SS state or CA state or remain in CR state. The 5-State NewReno algorithm 700 also uses congestion window (cwnd), slow start threshold (sst) and receiver window (rwnd) to control traffic congestion. The cwnd limits the number of packets that can be transmitted by a data sender over a path in a scheduling round and the rwnd indicates amount of data receiver is willing to accept. The 5-State NewReno algorithm 700 initiates cwnd to cwndₘᵢₙ and sstₛₜₐᵣₜ to the largest advertised rwnd or a value based on network path 701, then starts in slow start (SS) state 702. At the end of a scheduling round, the system 100 checks the 5-State NewReno algorithm 700 whether there is a packet loss 703. If there is no packet loss in a scheduling round, the algorithm 700 checks if 2*cwnd is greater than remaining congestion window cwndᵣₑₘ 704. If yes, the algorithm 700 transits to CR state 705 in which cwnd=cwndᵣₑₘ and stt remains. If not, the cwnd is doubled for the next scheduling round and stt remains 708. The algorithm 700 then checks if cwnd reaches stt 709. If no, the algorithm 700 transits to another SS state 702. If yes, the system 100 transits to CA state 710, in which the algorithm 700 checks packet loss 703. If no, the system 100 checks if cwnd+1 is greater than cwndᵣₑₘ 713. If yes, the algorithm 700 transits to CR state 705 and cwnd is set to cwndᵣₑₘ and stt remains 711. If cwnd+1 is less than cwndᵣₑₘ, the algorithm 700 checks if cwnd equals to cwndₘₐₓ 714. If yes, cwnd remains and algorithm 700 transits to SS state 702 or CA state 710. If not, cwnd is increased by 1 and stt remains 715. In either SS state 702 or CA state 710, if packet loss occurs in a scheduling round, the algorithm 700 transits to fast retransmit (FR) state 718 if the loss is triggered by three duplicate ACKs 716 and the lost packets can be recovered within the remaining window cwndᵣₑₘ 717 or otherwise to retransmit timeout (RTO) state 720. If the algorithm 700 transits to FR state 718, both sst and cwnd are set to cwnd/2 719. If the algorithm 700 transits to RTO state, sst is first set to cwnd/2 and cwnd is set to cwndₘᵢₙ 721.

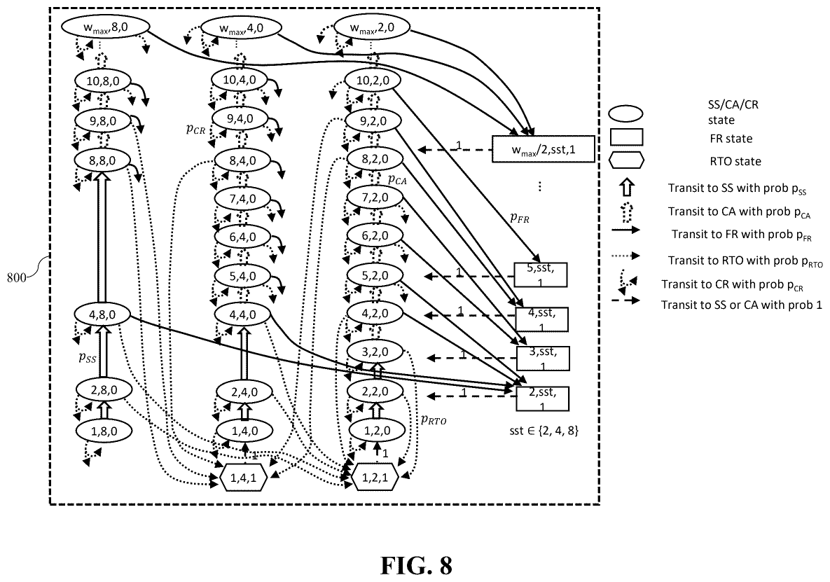

FIG. 8 depicts the Markov chain model 800 of the state transition in the 5-State NewReno congestion control algorithm, according to some embodiments. Markov chain model 800 of the state transition in the provided 5-State NewReno algorithm is with corresponding probability, where each state is represented by three state variables cwnd denoted as w, sst, and path loss 1, circles represent SS/CA/CR states, rectangles represent FR states and hexagons represent the RTO states. The sst values 2, 4, and 8 are used for illustration. Solid up arrows indicate SS state transition with probability pₛₛ, w=2w, sst=sst and l=1=0. Dash up arrows indicate CA state transition with probability p_{CA}, w=w+1, sst=sst and 1=1=0. Thick dash lines indicate state transitions from FR or RTO states to SS or CA states with probability 1, w=w, sst=sst and l transiting from 1 to 0. Double headed thin dash lines indicate state transitions from SS or CA states to CR states with probability p_{CR}, sst=sst, l=l=0 and w≤w, where “=” sign indicates staying at current state with w=w and “<” sign indicates transiting to a lower state with w<w. Solid long and short lines indicate state transitions to FR states with probability P_{FR}, l transiting from 0 to 1, sst=w/2 and w=w/2. Data thin long and short lines indicate state transitions to RTO states with probability P_{RTO}, l transiting from 0 to 1, sst=w/2 and w=wₘᵢₙ, where depending on the value of sst, the state transitions can move to left column, stay in current column, or move to right column.

This Markov chain model 800 can be used to compute the expected congestion window size w for scheduling.

### The Expected Congestion Window (Cwnd) Size w

For the easy of description, assume sst=2^{m}wₘᵢₙ and denote w as cwnd. The 5-State congestion control algorithm 700 starts with SS state and sets w to wₘᵢₙ with probability 1. At the SS state with w=2ⁱwₘᵢₙ, algorithm transits to next SS state with probability pₛₛ(2ⁱwₘᵢₙ) and w=2ⁱ⁺¹wₘᵢₙ (0≤i≤m−1). It transits to CA state with probability pₛₛ(2^{m} wₘᵢₙ) and w=2^{m}wₘᵢₙ+1. At CA state with w=2^{m}wₘᵢₙ+1, it transits to next CA state with probability p_{CA}(2^{m}wₘᵢₙ+j) and w=2^{m}wₘᵢₙ+j+1 (1≤j≤wₘₐₓ−2^{m}wₘᵢₙ−1). At CA state with w=wₘₐₓ, it remains in CA state with probability p_{CA}(wₘₐₓ) and w=wₘₐₓ.

In either SS state or CA state, the algorithm can transit to CR state. The probability of algorithm transiting from a SS state with w=2ⁱwₘᵢₙ to CR state is P_{CR} (2ⁱwₘᵢₙ) given by

p_{CR}(2ⁱwₘᵢₙ)=p(0|2ⁱwₘᵢₙ)P(T(1)+T(2)+ . . . +T(i+1)>SPᵣ|T(1)+T(2)+ . . . +T(i)<SPᵣ)

Assume that algorithm has uniform probability

$$\frac{1}{{2}^{i} {w}_{min}}$$

to have w=1, 2, . . . , 2ⁱwₘᵢₙ, the expected

$$w = \frac{{2}^{m} {w}_{min} + 1}{2} .$$

The probability of algorithm transiting from a CA state with w=2^{m}wₘᵢₙ+j to CR state is P_{CR}(2^{m}wₘᵢₙ+j) given by

$${p}_{CR} ( {2}^{m} {w}_{min} + j ) = p ( 0 \vert {2}^{m} {w}_{min} + j ) p ( T ( 1 ) + T ( 2 ) + ⋯ + T ( m + j + 1 ) > {SP}_{r} \vert \begin{matrix}T ( 1 ) + T ( 2 ) + ⋯ + \\ T ( m + j ) < {SP}_{r}\end{matrix} ) ) \qquad ( 1 )$$

Assume that algorithm has uniform probability

$$\frac{1}{{2}^{m} {w}_{min} + j}$$

to have w=1, 2, . . . , 2^{m}wₘᵢₙ, 2^{m}wₘᵢₙ+1, . . . , 2^{m}wₘᵢₙ+j, the expected

$$w = \frac{{2}^{m} {w}_{min} + j + 1}{2} .$$

In CR state, the algorithm does not have time to transit to any other state and therefore, scheduling ends.

In either SS state or CA state, the algorithm can transit to FR state. The probability of algorithm transiting from SS state with w=2ⁱwₘᵢₙ to a FR state is p_{FR}(2ⁱwₘᵢₙ) and w=2ⁱ⁻¹wₘᵢₙ. The probability of algorithm transiting from CA state with w=2ⁱwₘᵢₙ+j to a FR state is p_{FR}(2ⁱwₘᵢₙ+j) and

$$w = \frac{{2}^{i} {w}_{min} + j}{2} .$$

In either SS state or CA state, the algorithm can transit to RTO state. The probability of algorithm transiting from SS state with w=2ⁱwₘᵢₙ to RTO state is P_{RTO}(2ⁱwₘᵢₙ) and w=wₘᵢₙ. The probability of algorithm transiting from CA state with w=2ⁱwₘᵢₙ+j to RTO state is p_{RTO}(2ⁱwₘᵢₙ+j) and w=wₘᵢₙ.

In FR state, the algorithm transit to either SS state or CA state with probability 1. If algorithm transits to SS state, w=2^{i*-1} wₘᵢₙ, where i* is the largest integer that satisfies

$${2}^{{i}^{*} - 1} {w}_{min} \leq \frac{{2}^{i} {w}_{min} + j}{2} .$$

If algorithm transits to CA state,

$$w = \frac{{2}^{i} {w}_{min} + j}{2} .$$

Recall that w is halved by entering FR state. Therefore, in FR state, the maximum value of w is

$$\frac{{w}_{max}}{2} .$$

In RTO state, the algorithm transits to SS state with probability 1 and w=wₘᵢₙ.

Using the above information, the expected congestion window size is given by

$${w}_{exp} = ( 1 + {p}_{RTO} ) {w}_{min} + {p}_{FR} ( {w}_{max} ) {w}_{max} + \frac{{w}_{max}}{{\sum }_{j = 1}^{2}} {p}_{FR} ( {2}^{m} {w}_{min} + j ) \frac{{2}^{m} {w}_{min} + j}{2} + {\sum }_{i = 1}^{m} \{ {p}_{SS} ( {2}^{i} {w}_{min} ) {2}^{i + 1} {w}_{min} + {p}_{FR} ( {2}^{i} {w}_{min} ) {2}^{i - 1} {w}_{min} + {p}_{CR} ( {2}^{i} {w}_{min} ) \frac{{2}^{m} {w}_{min} + 1}{2} + {p}_{FR} ( {2}^{i} {w}_{min} ) {2}^{i - 1} {w}_{min} + {p}_{RTO} ( {2}^{i} {w}_{min} ) {w}_{min} \} + {\sum }_{j = 1}^{{w}_{max} - {2}^{m} {w}_{min}} \{ {p}_{CA} ( {2}^{m} {w}_{min} + j ) ( {2}^{m} {w}_{min} + j + 1 ) + {p}_{CR} ( {2}^{m} {w}_{min} + j ) \frac{{2}^{m} {w}_{min} + j + 1}{2} + {p}_{FR} ( {2}^{m} {w}_{min} + j ) \frac{{2}^{m} {w}_{min} + j}{2} + {p}_{RTO} ( {2}^{m} {w}_{min} + j ) {w}_{min} \} .$$

### Markov Chain Model of Wi-Fi CSMA/CA Function and Expected Number of Backoff Time Slots

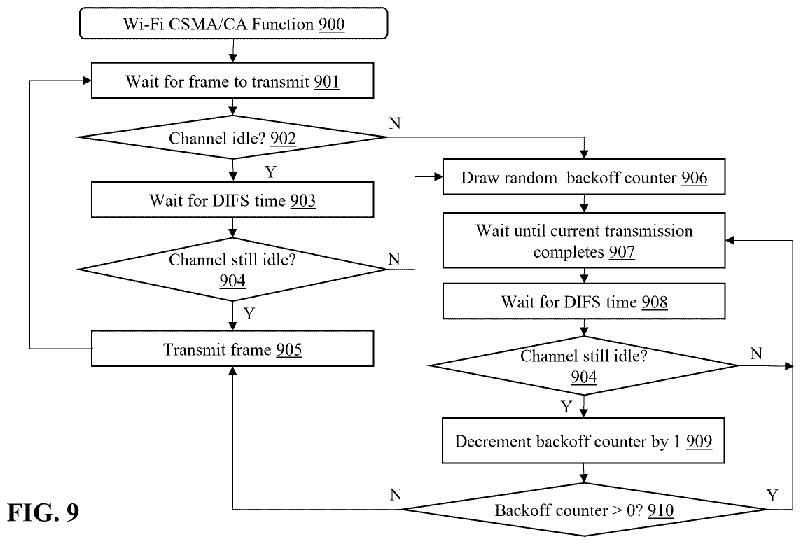

Wi-Fi supports CSMA/CA, i.e., DCF, by default, which is a contention-based channel access mechanism and mandatory for Wi-Fi devices. FIG. 9 illustrates the Wi-Fi CSMA/CA function 900, according to some embodiments. When a Wi-Fi device has a frame for transmission using CSMA/CA channel access 901, Wi-Fi CSMA/CA checks if channel is idle 902. If yes, Wi-Fi CSMA/CA waits for DIFS time 903. If the channel is still idle after DIFS time 904, Wi-Fi device makes immediate transmission 905 without backoff. If the channel is busy on either check, Wi-Fi CSMA/CA performs random backoff process. To do so, Wi-Fi CSMA/CA draws a random backoff counter 906, i.e., the number of backoff time slots, as described in the next paragraph and then waits until the current transmission completes 907. It then waits for DIFS time 908. After DIFS time, if the channel is still busy 904, it waits for the current transmission to be completed 907. If the channel is idle, Wi-Fi CSMA/CA checks channel condition in the next time slot. If the channel is busy, it waits for the current transmission to be completed. If the channel is idle, it decreases backoff counter by 1 and then checks if backoff counter is equal to zero 910. If yes, Wi-Fi CSMA/CA backoff succeeds and packet is transmitted 905. If not, Wi-Fi CSMA/CA backoffs remaining time slots. During backoff process, backoff counter is decremented by 1 for each idle time slot and suspended if the channel is busy. When the backoff counter is 0 and the channel is free, the frame is transmitted 905. Otherwise, backoff fails.

Depending on the length of a frame, Wi-Fi CSMA/CA can backoff up to dot11ShortRetryLimit or dot11LongRetryLimit times, denoted as r for short. Upon receiving a frame that requires ACK, Wi-Fi receiver transmits an ACK frame after SIFS time. At the backoff stage i (0≤i≤r), backoff counter is uniformly drawn in the range [0, Wᵢ], where Wᵢ is the contention window (CW) size satisfying CWₘᵢₙ≤Wᵢ≤CWₘₐₓ and Wᵢ=2ⁱW, i∈[0, m] and Wᵢ=2^{m}W, if r>m and i∈[m+1, r] with W=Cwₘᵢₙ being the minimum CW size and m being determined using the maximum CW size as CWₘₐₓ=2^{m}W. Wi-Fi CSMA/CA performs channel sense in each backoff time slot.

Wi-Fi CSMA/CA random backoff delay can be significant due to backoff suspension and therefore, must be considered in RTT computation. To that end, a fully functional Wi-Fi CSMA/CA model is needed. However, the existing Wi-Fi CSMA/CA models either consider retry limit r≤m only or lack backoff suspension. No existing Wi-Fi CSMA/CA model found considers Wi-Fi immediate channel access mechanism that can greatly impact Wi-Fi channel access delay in RTT computation under the non-saturated traffic condition, which is the typical traffic scenario in practical wireless networks.

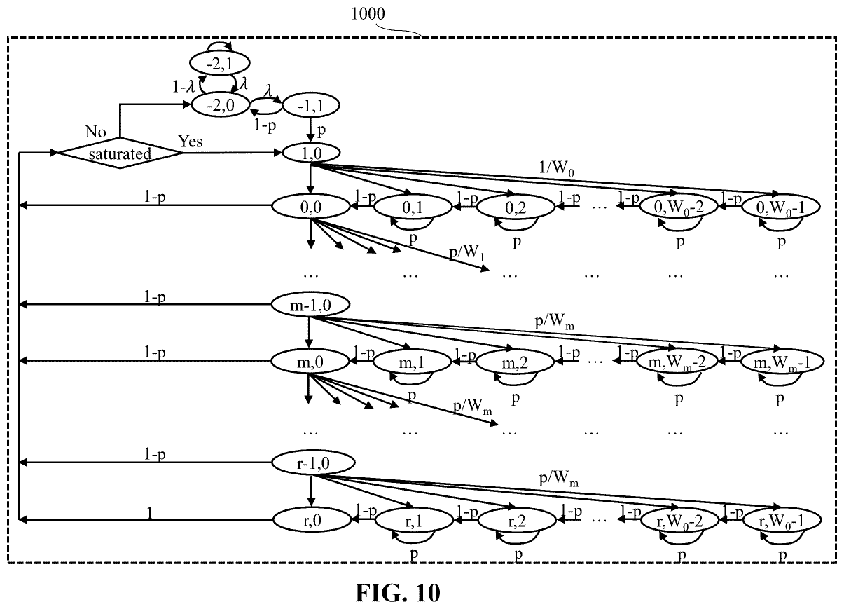

FIG. 10 depicts the Markov chain model 1000 of Wi-Fi CSMA/CA function, according to some embodiments. The Markov chain model 1000 incorporates immediate channel access, flexible retry limit r, backoff suspension, saturated and non-saturated traffic scenarios. In FIG. 10, each state is represented by two random variables, backoff stage s(t) and backoff counter b(t). Let b_{i,k}=lim_{t→∞}Pr(s(t)=i, b(t)=k), where i∈[0, r], k∈[0, Wᵢ]. To model immediate channel access and traffic scenario, four new states are introduced, b_{-1,0}, the backoff start state due to the busy channel or new packet transmission, b_{-1,1}, the state to attempt immediate channel access, b_{-2,0}, the data available state with probability λ, and b_{-2,1}, the data not available state with probability 1−λ. All b_{i,k} can be expressed using b_{0,0}. Assume the collision probability p of a transmitted packet is constant and independent of the number of retransmissions this packet has suffered in the past, following state transition probabilities have been obtained

Pr(i,k|i,k+1)=1−p,k∈[0,Wᵢ−2],i∈[0,r]

Pr(i,k|i,k)=p,k∈[0,Wᵢ−1],i∈[0,r]

Pr(i,k|i−1,0)=p/Wᵢ,k∈[0,Wᵢ−1],i∈[0,r−1]

Pr(−2,0|r,0,Non-saturated)=1

Pr(−2,0|i,0,Non-saturated)=1−p,i∈[0,r−1]

Pr(−2,1|−2,0)=1−λ

Pr(−2,0|−2,1)=λ

Pr(−2,1|−2,1)=1−λ

Pr(−2,0|−1,1)=1−p

Pr(−1,1|−2,0)=λ

Pr(−1,01−1,1)=p

Pr(−1,0|r,0,Saturated)=1

Pr(−1,0|i,0,Saturated)=1−p,i∈[0,r−1]

Pr(−2,1|−2,1)=1−λ

Pr(−2,01−1,1)=1−p

Pr(−1,1|−2,0)=λ

Pr(−1,01−1,1)=p

Pr(−1,0|r,0 & Saturated)=1

Pr(−1,0|i,0 & Saturated)=1−p,i∈[0,r−1] (1)

For non-saturate traffic, following relations hold

$${b}_{- 2 , 0} = ( 1 - p ) {\sum }_{i = 0}^{r - 1} {b}_{i , 0} + {b}_{r , 0} + λ {b}_{- 2 , 1} + ( 1 - p ) {b}_{- 1 , 1} \qquad ( 2 )$$

$${b}_{- 2 , 1} = ( 1 - λ ) {b}_{- 2 , 0} + ( 1 - λ ) {b}_{- 2 , 1}$$

$${b}_{- 1 , 0} = {pb}_{- 1 , 1}$$

$${b}_{- 1 , 1} = λ {b}_{- 2 , 0}$$

For saturated traffic, the following relation holds

$${b}_{- 1 , 0} = ( 1 - p ) {\sum }_{i = 0}^{r - 1} {b}_{i , 0} + {b}_{r , 0} \qquad ( 3 )$$

Using Markov model, the following relations can be obtained

$${pb}_{i - 1 , 0} = {b}_{i , 0} , i ∈ [ 1 , r ] , i . e . , {b}_{i , 0} = {p}^{i} {b}_{0 , 0} , i ∈ [ 0 , r ] \qquad ( 4 )$$

$${b}_{i , k} = \frac{{w}_{i} - k}{( 1 - p ) {w}_{i}} {b}_{i , 0} , i ∈ [ 0 , r ] , k ∈ [ 1 , {W}_{i} - 1 ]$$

By applying the normalization condition, for non-saturated traffic,

$${\sum }_{k = 0}^{1} ( {b}_{- 2 , k} + {b}_{- 1 , k} ) + {\sum }_{i = 0}^{r} {\sum }_{k = 0}^{{W}_{k} - 1} {b}_{i , k} = 1 holds$$

and for saturated traffic,

$${b}_{- 1 , 0} + {\sum }_{i = 0}^{r} {\sum }_{k = 0}^{{W}_{k} - 1} {b}_{i , k} = 1 holds .$$

Accordingly, under non-saturated traffic condition, b_{0,0} is solved as

$${b}_{0 , 0} = \{ \begin{matrix}\frac{2 {λ}^{2} ( 1 - 2 p ) {( 1 - p )}^{2}}{{D}_{1}} , & r \leq m \\ \frac{2 {λ}^{2} ( 1 - 2 p ) {( 1 - p )}^{2}}{{D}_{2}} , & r > m\end{matrix} \qquad ( 5 )$$

and under saturated traffic condition, b_{0,0} is solved as

$${b}_{0 , 0} = \{ \begin{matrix}\frac{2 p ( 1 - 2 p ) {( 1 - p )}^{2}}{{D}_{3}} , & r \leq m \\ \frac{2 p ( 1 - 2 p ) {( 1 - p )}^{2}}{{D}_{4}} , & r > m\end{matrix} \qquad ( 6 )$$

where D₁=2[1+λ²(1+p)](1−p)²(1−2p)+λ²p(1−2p)(1−p^{r+1})+λ²p(1−p) 1−(2p)^{r+1}]W, D₂=2[1+λ²(1+p)](1−p)²(1−2p)+λ²p(1−2p)(1−p^{r+1})+λ²p(1−p)[1−(2p)^{r+1}]W+λ²p(1−2p)2ₘp^{m+1}[1−p^{r-m}]W D₃=2(1−p)³(1−2p)+p(1−2p)(1−p^{r+1})+p(1−p)[1−(2p)^{r+1}]W, and D₄=D₃+p(1−2p)2^{m}p^{m+1}(1−p^{r-m})W.

To transmit a data frame via random backoff channel access, Wi-Fi CSMA/CA conducts the 0-th backoff with probability 1. It conducts the i-th backoff only if the previous i backoffs from the 0-th backoff to the (i−1)-th backoff have failed due to the busy channel. Therefore, the probability of Wi-Fi CSMA/CA conducting the i-th backoff is

$${\prod }_{k = 0}^{i - 1} {b}_{k , 0} = {\prod }_{k = 0}^{i - 1} {p}^{k} {b}_{0 , 0} ( i = 1 , 2 , … , r ) .$$

Consider that the expected number of time slots drawn on the i-th backoff is

$$\frac{{w}_{i} + 1}{2}$$

and any TCP packet is considered as data frame at Wi-Fi MAC layer, the expected number of time slots to backoff for a MPTCP packet is given by

$${N}_{ts} = \frac{{w}_{0} + 1}{2} {b}_{0 , 0} + {\sum }_{i = 1}^{r} {\prod }_{k = 0}^{i - 1} \frac{{w}_{i} + 1}{2} {p}^{k} {b}_{0 , 0} . \qquad ( 7 )$$

### RTT Computation Over Heterogeneous Wi-Fi and 5G Path

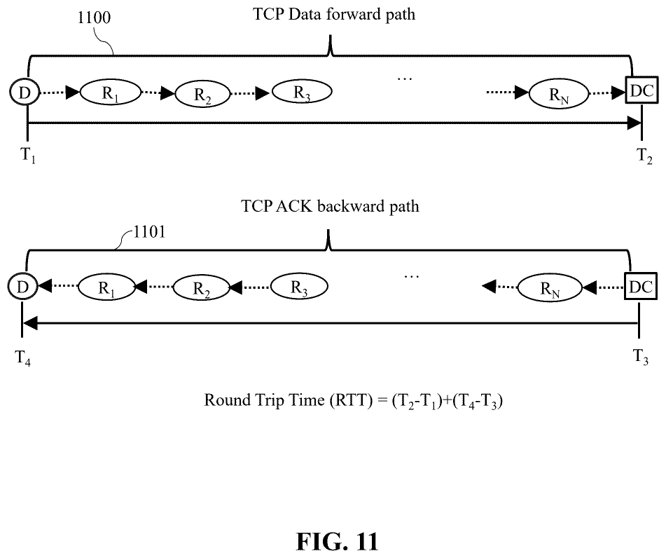

FIG. 11 depicts a round trip time (RTT) computation over a multi-hop MPTCP path in multi-hop Wi-Fi and 5G networks using TCP data packet and TCP acknowledgement (ACK) packet, according to some embodiments.

Round trip time (RTT) is a required parameter in MPTCP scheduling. IETF RFC 793 defines RTT as the elapsed time between sending a data octet and receiving an acknowledgment. However, no existing art found addresses RTT computation over heterogeneous Wi-Fi and 5G networks. Furthermore, some arts assume multiple packets can be transmitted within a RTT time period, which is not necessarily true depending on how RTT is computed.

Instead of using a data octet as in IETF RFC 793, the present disclosure uses TCP data packet and TCP ACK packet to compute RTT since these TCP packets are used in TCP transport layer for data transfer. Consider a heterogeneous path from data node D to data center DC with N relay nodes shown in FIG. 11, where R₀=D→R₁→R₂→R₃→ . . . Rₙ→Rₙ₊₁→ . . . →R_{N-1}→R_{N}→DC is the forward path 1100 and R_{N+1}=DC→R_{N}→R_{N-1}→R_{N-3}→ . . . →Rₙ₊₁→Rₙ→ . . . →R₂→R₁→D is backward path 1101. Nodes R_{N-1} and R_{N} can be 5G nodes or 5G base stations. TCP data packet is sent from data node D to data center DC. Upon receiving TCP data packet, data center DC sends TCP ACK packet back to data node D. If TCP data packet is sent at time T₁ by data node D and received by data center DC at time T₂ and TCP ACK packet is sent by data center DC at time T₃ and received by data node D at time T₄, then the RTT on this path is given by

RTT=(T₂−T₁)+(T₄−T₃).

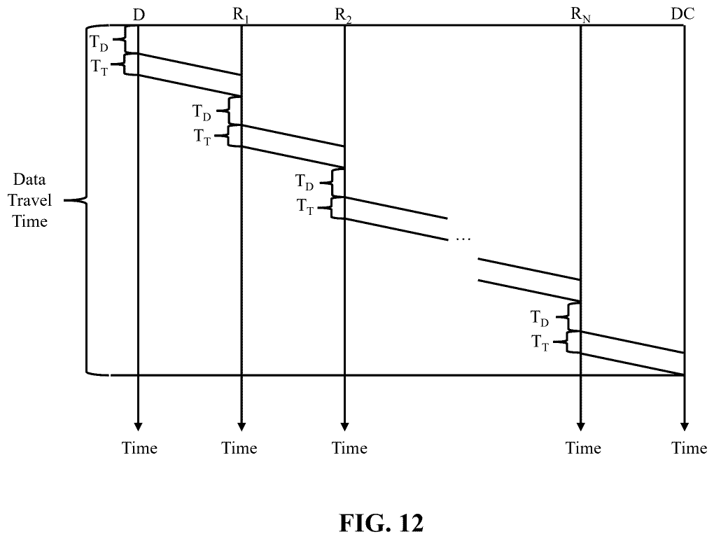

FIG. 12 depicts a hop-to-hop RTT computation over a multi-hop MPTCP path in multi-hop wireless networks, according to some embodiments. FIG. 12 illustrates the hop-by-hop data packet travel time (DPTT), i.e., T₂−T₁. In other words, DPTT is the time needed for one data packet to travel from data node D to data center DC. At each hop, there are two classes of time consumption, delay time T_{D} and packet transmission time T_{T}. For a Wi-Fi node, T_{D} includes queuing time, channel access backoff time and interframe space time and T_{T} includes data packet transmission time and MAC ACK transmission time. For 5G node, T_{D} includes queuing time and T_{T} includes data packet transmission time. The ACK packet travel time (APTT), i.e., T₄−T₃, can be similarly illustrated.

More specifically, at a Wi-Fi node, the time a TCP packet consumed includes (1) random queuing time, (2) fixed DIFS time, (3) random backoff time, (4) fixed packet transmission time, (5) fixed SIFS time and (6) fixed MAC ACK transmission time. On the other hand, the time a TCP packet consumed at a 5G node only includes (1) random queuing time and (2) fixed packet transmission time. Therefore, the task is to compute random queuing time of both Wi-Fi node and 5G node and random backoff time of Wi-Fi node.

Expected queuing time: The M/M/1/K queue can be used to compute the expected queuing time. Assume each node has one queue of size K with a single server and packet arrives according to a Poisson process with rate λ (packets/s). The service process follows an exponential distribution with rate y (packets/s). Let B₁ᵢ and B_{5g} be Wi-Fi bandwidth and 5G bandwidth, respectively, then

$$μ = \frac{{B}_{11}}{8 * P a cketSize} and \frac{{B}_{5 g}}{8 * P a cketSize} ,$$

respectively. Denote as

$$ρ = \frac{λ}{μ} .$$

From the M/M/1/K queue theory, the probability that queue contains n (n=0, 1, 2, . . . , K) packets is

$${p}_{n} = \{ \begin{matrix}1 / ( K + 1 ) , & ρ = 1 \\ ( 1 - ρ ) n / ( 1 - {ρ}^{K + 1} ) , & ρ \neq 1\end{matrix} \qquad ( 8 )$$

Therefore, the probability that a packet is lost due to queue overflow (i.e., n=K) is

$${p}_{K} = \{ \begin{matrix}1 / ( K + 1 ) , & ρ = 1 \\ ( 1 - ρ ) {ρ}^{K} / ( 1 - {ρ}^{K + 1} ) , & ρ \neq 1\end{matrix} \qquad ( 9 )$$

Let N_{q} be the expected number of packets in the queue, the N_{q} can be calculated as

$${N}_{q} = \{ \begin{matrix}K / 2 , & ρ = 1 \\ ρ / ( 1 - ρ ) - ( K + 1 ) / ( 1 - {ρ}^{K + 1} ) , & ρ \neq 1\end{matrix} \qquad ( 10 )$$

Assume queue is not full (otherwise packet is discarded), then considering current packet being added into the queue, the expected queuing time T_{q} is given by

T_{q}=(N_{q}+1)/μ. (11)

RTT computation: The expected time consumed by a MPTCP data packet at a Wᵢ-Fi node Rₙ via immediate channel access is given by

$${T}_{D} ( {R}_{n} ) = DIFS + \frac{\vert Data \vert}{{B}_{11}} + SIFS + {T}_{MAC - ACK ,} \qquad ( 12 )$$

where |Data| is the size of MPTCP data packet.

Using the expected queuing time T_{q} given in Equation (11) and the expected number of backoff time slots Nₜₛ given in Equation (7), the expected time consumed by a MPTCP data packet at a Wi-Fi node Rₙ via random backoff channel access is given by

$${T}_{Data} ( {R}_{n} ) = {T}_{q} + DIFS + {N}_{ts} \times {TS}_{len} + \frac{\vert Data \vert}{{B}_{11}} + SIFS + {T}_{MAC - ACK} , \qquad ( 13 )$$

where TSₗₑₙ is Wi-Fi time slot length.

On the other hand, the expected time spent by a MPTCP data packet at a 5G node Rₙ is given by

$${T}_{Data} ( {R}_{n} ) = {T}_{q} + \frac{\vert Data \vert}{{B}_{5 G}} , \qquad ( 14 )$$

Therefore, the expected MPTCP data packet travel time (DPTT), i.e., T₂−T₁, over N+1 hop path from data node D to DC can be computed as

$${T}_{2} - {T}_{1} = {\sum }_{n = 0}^{N} {T}_{Data} ( {R}_{n} ) . \qquad ( 15 )$$

Denote as R_{N+1}=DC, the expected MPTCP ACK packet travel time (APTT), i.e., T₄−T₃, over N+1 hop path from DC to node D can be computed similarly as

$${T}_{4} - {T}_{3} = {\sum }_{n = N + 1}^{1} {T}_{ACK} ( {R}_{n} ) . \qquad ( 16 )$$

Therefore, the RTT over path P is given by

$$RTT = ( {T}_{2} - {T}_{1} ) + ( {T}_{4} - {T}_{3} ) = {\sum }_{n = 0}^{N} {T}_{Data} ( {R}_{n} ) + {\sum }_{n = N + 1}^{1} {T}_{ACK} ( {R}_{n} ) . \qquad ( 17 )$$

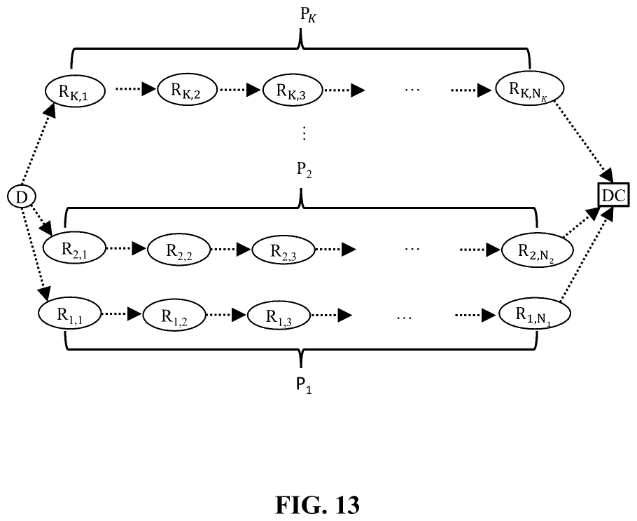

FIG. 13 depicts a MPTCP path scheduling from a data node D to a data center (DC) on K paths, according to some embodiments.

### Loss-Aware MPTCP Path Scheduling

MPTCP scheduling is to schedule packet transmissions over multiple paths to ensure packets over multiple paths arrive at data center DC in order and all paths are efficiently utilized. In wireless IoT networks, the dedicated routers installed in conventional computer networks are typically not available. As a result, a data node D not only delivers its data packets but may also relay packets for other nodes. This makes MPTCP path scheduling in wireless IoT networks different from that in computer networks. Data packets can be scheduled based on first come first serve principle or packet priority or other criteria.

Assume a data node D has K (K≤NPₜ) paths P₁, P₂, . . . , P_{K} to data center arranged in the RTT ascending order as illustrated in FIG. 13, where K paths have different lengths N₁+1 hops, N₂+1 hops, . . . , N_{K}+1 hops, respectively. Consider a path Pᵢ(i=1, 2, . . . K) and denote as wᵢ the congestion window (cwnd) of path Pᵢ for short. Assume TCP ACK is delayed for wᵢ packets, and a new round starts after the current round is completed. Denote as

$${B}_{i}^{D}$$

either B₁₁ if data node D on the path Pᵢ is a Wi-Fi node or B_{5G} if node D is a 5G node. Let

$${T}_{i}^{j}$$

be the time needed to delivery j data packets over path Pᵢ, then

$${T}_{i}^{1} = {DPTT}_{i} .$$

Consider that Wi-Fi protocol (IEEE 802.11 standard) specifies a transmission opportunity (TXOP) mechanism, in which once a device obtains a TXOP, it can make consecutive frame transmissions with SIFS interframe space. Therefore, the travel time of j data packets is given by

$${T}_{i}^{j} = {T}_{i}^{1} + ( j - 1 ) ( SIFS + \frac{\vert Data \vert}{{B}_{i}^{D}} ) . \qquad ( 18 )$$

Since the first MPTCP data packet scheduled on the slowest path P_{K} takes

$${T}_{K}^{1}$$

time to arrive at DC, the MPTCP data packets scheduled on path P_{K-1} should arrive at DC no later than

$${T}_{K}^{1} .$$

Similarly, since the first MPTCP data packet scheduled on path P_{K-1} takes

$${T}_{K - 1}^{1}$$

time to arrive at DC, the MPTCP data packets scheduled on path P_{K-2} should arrive at DC no later than

$${T}_{K - 1}^{1} .$$

This constraint continues until the end, since the first MPTCP data packet scheduled on P₂ takes

$${T}_{2}^{1}$$

time to arrive at DC, the MPTCP data packets scheduled on the fastest path P₁ should arrive at DC no later than

$${T}_{2}^{1} .$$

Therefore, paths are scheduled from the slowest path P_{K} to the fastest path P₁. The scheduling process is a tree-like approach with P_{K}, P_{K-1}, . . . , P₁ at the root level, first branch level, . . . , (K−1)-th branch level, respectively. For path P_{K}, w_{K} packets can be scheduled. For a path Pᵢ(1≤i≤K),

$${T}_{i + 1}^{1}$$

is used as scheduling period. The task is to calculate the number of data packets that can be scheduled on path Pᵢ within time period

$${T}_{i + 1}^{1} .$$

At least one data packet can be scheduled on path Pᵢ since

$${T}_{i}^{1} \leq {T}_{i + 1}^{1} .$$

It is possible that multiple scheduling rounds can complete within

$${T}_{i + 1}^{1}$$

time. Denote as Tᵢ(r) and wᵢ(r) the remaining time within the scheduling period

$${T}_{i + 1}^{1}$$

and the wᵢ at the start of the r-th scheduling round, respectively. The scheduling process continues until remaining time Tᵢ(r) is not enough for one data packet transmission. Let denote as |ACK| the TCP ACK packet size. Thus, there are following five scheduling cases at the r-th round over path Pᵢ:

$${T}_{i} ( r ) < {T}_{i}^{1} + {APTT}_{i} :$$

There is not enough time to complete one data packet transmission, thus scheduling ends.

$${T}_{i}^{1} + {APTT}_{i} \leq {T}_{i} ( r ) < {T}_{i}^{{w}_{i} ( r )} + A P T {T}_{i} :$$

There is not enough time to transmit conventional wᵢ(r) data packets, but there is time to transmit

$${w}_{i}^{*} ( r )$$

data packets, where

$${w}_{i}^{*} ( r ) ∈$$

[1, wᵢ(r)) is the largest integer satisfying

$${T}_{i}^{{w}_{i}^{*} ( r )} + A T {T}_{i} \leq {T}_{i} ( r ) .$$

However, there is not enough time for recovery or starting the (r+1)-th round, thus Tᵢ(r+1)=0 and wᵢ(r+1)=0. This case corresponds to the invented CR state transmission.

$${T}_{i}^{{w}_{i} ( r )} + {APTT}_{i} \leq {T}_{i} ( r ) < {T}_{i}^{{w}_{i} ( r )} + {APTT}_{i} + 2 \vert ACK \vert / {B}_{i}^{DC} + {T}_{i}^{1} :$$

There is time to transmit wᵢ(r) data packets, but not enough time for recovery or starting the (r+1)-th round, thus Tᵢ(r+1)=0 and wᵢ(r+1)=0.

$${T}_{i}^{{w}_{i} ( r )} + {APTT}_{i} + 2 \vert ACK \vert / {B}_{i}^{DC} + {T}_{i}^{1} \leq {T}_{i} ( r ) < {RTO}_{i} + {T}_{i}^{1} :$$

There is time to complete the r-th round and start the (r+1)-th round if the lost packets can be recovered by FR, but there is not enough time to complete RTO retransmission. Therefore, the (r+1)-th round will not start if lost data packets cannot be recovered by FR. There could be three sub-cases:

Sub-case 4-1: No data packet loss. In this sub-case, wᵢ(r) packets can be scheduled, the (r+1)-th will start in SS or CA or CR state with probability

$$p ( 0 \vert {w}_{i} ( r ) ) = ( \begin{matrix}{w}_{i} ( r ) \\ 0\end{matrix} ) {{l}^{0} ( 1 - l )}^{{w}_{i} ( r )} , {T}_{i} ( r + 1 ) = {T}_{i} ( r ) - ( {T}_{i}^{{w}_{i} ( r )} + {APTT}_{i} ) , s s {t}_{i} ( r + 1 ) = s s {t}_{i} ( r ) , {w}_{i} ( r + 1 ) = \{ \begin{matrix}2 * {w}_{i} ( r ) , & {w}_{i} ( r ) < ss {t}_{i} ( r ) \\ {w}_{i} ( r ) + 1 , & ss {t}_{i} ( r ) \leq {w}_{i} ( r ) < {w}_{i}^{max} \\ {w}_{i} ( r ) , & {w}_{i} ( r ) \geq {w}_{i}^{max}\end{matrix}$$

Sub-case 4-2: With data packet loss, but the number of lost data packets n≤wᵢ(r)−3 with probability

$${\sum }_{n = 1}^{{w}_{i} ( r ) - 3} ( \begin{matrix}{w}_{i} ( r ) \\ n\end{matrix} ) {{l}^{n} ( 1 - l )}^{{w}_{i} ( r ) - n}$$

so that lost data packets can be recovered by FR. In this sub-case, wᵢ(r) packets can be scheduled, the (r+1)-th round starts in SS or CA state with probability 1,

$${T}_{i} ( r + 1 ) = {T}_{i} ( r ) - ( {T}_{i}^{{w}_{i} ( r )} + {APTT}_{i} + 2 \vert ACK \vert / {B}_{i}^{D C} + {\sum }_{n = 1}^{{w}_{i} ( r ) - 3} ( \begin{matrix}{w}_{i} ( r ) \\ n\end{matrix} ) {{l}^{n} ( 1 - l )}^{{w}_{i} ( r ) - n} {T}_{i}^{n} ) , {w}_{i} ( r + 1 ) = {sst}_{i} ( r + 1 ) = ⌊ {w}_{i} ( r ) / 2 ⌋ .$$

Sub-case 4-3: With data packet loss, but the number of lost packets n>wᵢ (r)−3 is large enough with probability

$${\sum }_{n = {w}_{i} ( r ) - 2}^{{w}_{i} ( r )} ( \begin{matrix}{w}_{i} ( r ) \\ n\end{matrix} ) {{l}^{n} ( 1 - l )}^{{w}_{i} ( r ) - n}$$

so that lost data packets cannot be recovered by FR. In this sub-case, wᵢ(r) packets can be scheduled, but the time is not enough to trigger RTO, thus the (r+1)-th round will not start, thus Tᵢ(r+1)=0 and wᵢ(r+1)=0.

5. Tᵢ(r)≥RTOᵢ+Tᵢ¹: Time is enough to complete the r-th round, retransmit lost packets via FR or RTO and start the (r+1)-th round. There could also be three sub-cases:
Sub-case 5-1: Same as Case 4-1.
Sub-case 5-2: Same as Case 4-2.
Sub-case 5-3:

With data packet loss and the number of lost data packets n>wᵢ(r)−3 with probability

$${\sum }_{n = {w}_{i} ( r ) - 2}^{{w}_{i} ( r )} ( \begin{matrix}{w}_{i} ( r ) \\ n\end{matrix} ) {{l}^{n} ( 1 - l )}^{{w}_{i} ( r ) - n}$$

so that lost data packets can be only recovered by RTO. In this sub-case, wᵢ(r) packets can be scheduled, the (r+1)-th round will start in SS state with probability 1.

$${T}_{i} ( r + 1 ) = {T}_{i} ( r ) - ( {T}_{i}^{{w}_{i} ( r )} + {RTO}_{i} ) , {sst}_{i} ( r + 1 ) = ⌊ {w}_{i} ( r ) / 2 ⌋ and {w}_{i} ( r + 1 ) = {w}_{i}^{min} .$$

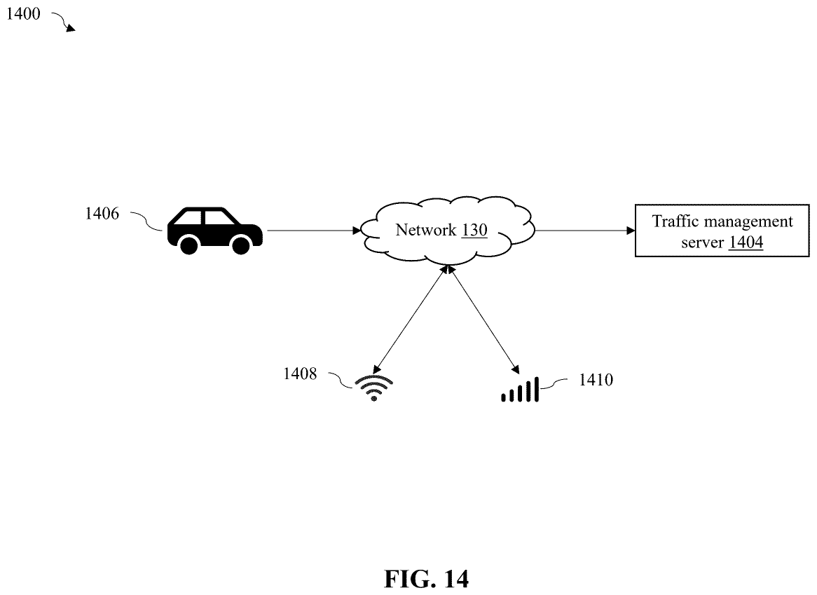

FIG. 14 depicts a flow diagram illustrating a use case for modeling multipath TCP over heterogenous Wi-Fi and 5G networks, according to some embodiments. FIG. 14 includes an environment 1400 which comprises an autonomous car 1406 that communicates with a network 130 using multiple wireless interfaces, such as Wi-Fi 1408 and cellular network 1410. The network 130 is further connected to a traffic management server 1404.

The autonomous car 1406 operates within a traffic infrastructure where timely and accurate communication with the traffic management server 1404 is essential. The traffic management server 1404 provides services such as real-time congestion monitoring, route optimization, accident detection, and traffic signal coordination. To ensure uninterrupted data flow between the autonomous vehicle 1406 and the traffic management server 1404, the system 100 leverages both Wi-Fi 1408 and 5G 1410 links to interface with the network 130.

As the autonomous car 1406 navigates the road environment, the autonomous car 1406 continuously sends telemetry data including speed, position, route preference, and sensor observations to the traffic management server 1404. The data is transmitted via the network 130, which acts as a middleware entity capable of dynamically routing traffic based on available wireless interfaces. The Wi-Fi 1408 path may be used for regular updates or when operating in connectivity-rich environments such as urban centers. Conversely, the 5G path 1410 may be prioritized for low-latency communication needs, such as in emergency maneuvers or when responding to dynamic traffic conditions.

On the downlink side, the traffic management server 1404 pushes data such as optimized routing instructions, hazard alerts, and adaptive signal control commands back to the autonomous car 1406. The network 130 intelligently manages the communication flows by selecting the most suitable link or distributing traffic over both links using techniques such as Multipath TCP (MPTCP). The multipath strategy enhances reliability by allowing seamless path switching or concurrent usage.

The 5-State NewReno congestion control, embedded within the MPTCP, operates independently on each subflow TCP. However, MPTCP also includes coupled congestion control, which enables coordination between the Wi-Fi and 5G paths. For instance, if the Wi-Fi link becomes congested while 5G remains underutilized, the 5-State NewReno algorithm reduces the congestion window on the Wi-Fi path while maintaining throughput via the 5G subflow. As the autonomous car 1406 moves through environments with variable connectivity, such as urban intersections, rural highways, or tunnels, MPTCP with 5-State NewReno algorithm guarantees seamless, adaptive communication. Real-time data from the traffic management server 1404 may continue to flow without disruption, empowering the autonomous car 1406 to make intelligent, safety-critical driving decisions.

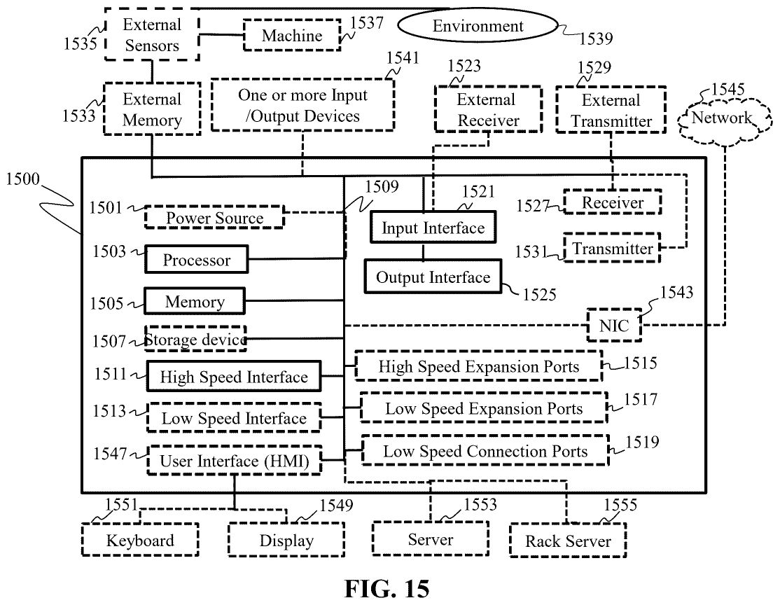

FIG. 15 illustrates some components of a system for modeling multipath TCP over heterogenous Wi-Fi and 5G networks, according to some embodiments. The system 1500 includes a power source 1501, a processor 1503, a memory 1505, a storage device 1507, all connected to a bus 1509. Further, a high-speed interface 1511, a low-speed interface 1513, high-speed expansion ports 1515 and low speed connection ports 1517, can be connected to the bus 1509. In addition, a low-speed expansion port 1519 is in connection with the bus 1509. Further, an input interface 1521 can be connected via the bus 1509 to an external receiver 1523 and an output interface 1525. A receiver 1527 can be connected to an external transmitter 1529 and a transmitter 1531 via the bus 1509. Also connected to the bus 1509 can be an external memory 1533, external sensors 1535, machine(s) 1537, and an environment 1539. Further, one or more external input/output devices 1541 can be connected to the bus 1509. A network interface controller (NIC) 1543 can be adapted to connect through the bus 1509 to a network 1545, wherein data or other data, among other things, can be rendered on a third-party display device, third party imaging device, and/or third-party printing device outside of the system 1500.

The memory 1505 may store instructions that are executable by the system 1500 and any data that can be utilized by the methods and systems of the present disclosure. The memory 1505 can include random access memory (RAM), read only memory (ROM), flash memory, or any other suitable memory systems. The memory 1505 can be a volatile memory unit or units, and/or a non-volatile memory unit or units. The memory 1505 may also be another form of computer-readable medium, such as a magnetic or optical disk.

The storage device 1507 can be adapted to store supplementary data and/or software modules used by the system 1500. The storage device 1507 can include a hard drive, an optical drive, a thumb-drive, an array of drives, or any combinations thereof. Further, the storage device 1507 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 1503), perform one or more methods, such as those described above.

The system 1500 can be linked through the bus 1509, optionally, to a display interface or user Interface (HMI) 1547 adapted to connect the system 1500 to a display device 1549 and a keyboard 1551, wherein the display device 1549 can include a computer monitor, camera, television, projector, or mobile device, among others. In some implementations, the system 1500 may include a printer interface to connect to a printing device, wherein the printing device can include a liquid inkjet printer, solid ink printer, large-scale commercial printer, thermal printer, UV printer, or dye-sublimation printer, among others.

The high-speed interface 1511 manages bandwidth-intensive operations for the system 1500, while the low-speed interface 1513 manages lower bandwidth-intensive operations. Such allocation of functions is an example only. In some implementations, the high-speed interface 1511 can be coupled to the memory 1505, the user interface (HMI) 1545, and to the keyboard 1551 and the display 1549 (e.g., through a graphics processor or accelerator), and to the high-speed expansion ports 1515, which may accept various expansion cards via the bus 1509. In an implementation, the low-speed interface 1513 is coupled to the storage device 1507 and the low-speed expansion ports 1517, via the bus 1509. The low-speed expansion ports 1517, which may include various communication ports (e.g., USB, Bluetooth, Ethernet, wireless Ethernet) may be coupled to the one or more input/output devices 1541. The system 1500 may be connected to a server 1553 and a rack server 1555. The system 1500 may be implemented in several different forms. For example, the system 1500 may be implemented as part of the rack server 1555.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a FIG. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A node device for a heterogeneous communication network that supports multi-hop Wi-Fi and 5G communication, the heterogeneous communication network including single-interface data nodes, multi-interface data nodes, data centers, and a 5G base station network, the node device comprising:
a transceiver configured to communicate data packets in the heterogeneous network;
a memory configured to store computer executable programs for executing a Multipath transmission control protocol (MPTCP), a 5-State NewReno congestion control algorithm, and a loss-aware MPTCP path scheduling method for transmission of the data packets over multiple paths in the heterogeneous communication network; and
a processor configured to perform steps of the computer executable programs, wherein the steps comprise:
computing a congestion window for the communication by using the 5-State NewReno algorithm and determining a minimum congestion window and a maximum congestion window for the communication;
computing a round trip time (RTT) for each heterogenous path of multiple heterogeneous Wi-Fi and 5G paths in the communication network; and
scheduling, transmission of the data packets along the multiple heterogeneous Wᵢ-Fi and 5G paths formed from the data node to the data center, based on the congestion window, the minimum congestion window, the maximum congestion window, and the RTT for each path of the multiple heterogeneous Wi-Fi and 5G paths.

2. The node device of claim 1, wherein the 5-State NewReno congestion control algorithm determines the congestion window for each MPTCP path in a scheduling round of the MPTCP loss-aware path scheduling method.

3. The node device of claim 2, wherein the congestion window is a parameter to limit the number of data packets that can be scheduled along an MPTCP path in a scheduling round such that the number of data packets scheduled in a scheduling round is less than the congestion window.

4. The node device of claim 2, wherein the 5-State NewReno congestion control algorithm defines two new conditions: (1) a first condition that the congestion window remains unchanged under no packet loss condition, and (2) a second condition that the congestion window decreases under no packet loss condition.

5. The node device of claim 2, wherein a Markov chain model is provided to compute an expected congestion window value in the 5-State NewReno congestion control algorithm.

6. The node device of claim 1, wherein a MPTCP path in the heterogeneous network is one of a homogeneous Wi-Fi node only path, a homogeneous 5G node only path, or a mixed Wi-Fi and 5G node path.

7. The node device of claim 1, wherein the loss-aware MPTCP data packet scheduling method applies the RTT, the congestion window, a loss rate and a number of paths to determine the number of packets to be transmitted along an MPTCP path in a scheduling round.

8. The node device of claim 7, wherein the RTT for a MPTCP path is an elapsed time between sending a data packet by a data node to the data center along the MPTCP path and receiving an acknowledgment (ACK) from the data center by the data node along the same MPTCP path.

9. The node device of claim 7, wherein the time consumed by a TCP packet at a Wi-Fi node includes (1) random queuing time, (2) fixed DIFS time, (3) random backoff time, (4) fixed packet transmission time, (5) fixed SIFS time, and (6) fixed Wi-Fi MAC ACK transmission time.

10. The node device of claim 7, wherein the time consumed by a TCP packet at a 5G node includes (1) random queuing time and (2) fixed packet transmission time.

11. The node device of claim 9, wherein the random queuing time is computed by applying the M/M/1K queue.

12. The node device of claim 11, wherein the random queuing time spent by the TCP data packet or the TCP ACK packet is computed as
$$\frac{{N}_{q} + 1}{μ} ,$$
where N_{q} is the number of packets in the queue and μ is the packet transmission rate.

13. The node device of claim 9, wherein the random backoff time at a Wi-Fi node is computed using a provided Markov chain model that integrates immediate channel access, flexible backoff retry limit, backoff suspension, saturated and non-saturated traffic scenarios.

14. The node device of claim 7, wherein the elapsed time is a sum of the time spent by the TCP data packet traverses from the data node to the data center along the MPTCP path and the time spent by the TCP ACK packet traverses from the data center to the data node along same MPTCP path.

15. The node device of claim 13, wherein the time spent by the TCP data packet is sum of the time spent by the TCP data packet at all nodes along the MPTCP path, wherein the time spent by the TCP ACK packet is sum of the time spent by the TCP ACK packet at all nodes along the same MPTCP path.

16. The node device of claim 13, wherein the random backoff time consumed by a TCP packet at a Wi-Fi node is computed as Nₜₛ×TSₗₑₙ, where TSₗₑₙ is the length of the Wi-Fi backoff time slot and Nₜₛ is the expected number of backoff time slots.

17. The node device of claim 1, wherein the loss-aware scheduling method schedules packet transmissions over multiple MPTCP paths, wherein a MPTCP path with the smaller RTT is scheduled to transmit more data packets in a scheduling round, wherein a MPTCP path with the larger RTT is scheduled to transmit fewer data packets in a scheduling round, wherein a MPTCP path with smaller loss rate is scheduled to transmit more data packets in a scheduling round, wherein a MPTCP path with the greater loss rate is scheduled to transmit fewer data packets in a scheduling round.

18. The node device of claim 17, wherein a scheduling round for an MPTCP path is the time needed to transmit all data packets scheduled, wherein the success of data packet transmission is confirmed by the acknowledgement from the data center.

19. The node device of claim 17, wherein the loss-aware scheduling method arranges MPTCP paths P₁, P₂, . . . , P_{K} of a data node in RTT ascending order as RTT₁≤RTT₂≤ . . . ≤RTT_{K} (K≤NPₜ), wherein the corresponding congestion windows are determined as cwnd₁, cwnd₂, . . . , cwnd_{K}, respectively, wherein the cwndᵢ packets are scheduled for MPTCP path Pᵢ in a scheduling round (i=1, 2, . . . , K), wherein the time need to transmit the cwnd_{K} data packets serves as scheduling period for MPTCP path P_{K}, wherein the data packet travel time (DPTT) over MPTCP path Pᵢ serves as scheduling period for MPTCP path Pᵢ₋₁ (i=K, K−1, . . . , 2), wherein only one scheduling round takes place for MPTCP path P_{K}, wherein multiple scheduling round can take place for MPTCP paths P₁, P₂, . . . , P_{K-1} within the corresponding scheduling period depending on packet loss.

20. The node device of claim 19, wherein the number of data packets scheduled for an MPTCP path Pᵢ(i=1, 2, . . . , K−1) within a scheduling period is sum of the data packets scheduled in all multiple rounds.

21. The node device of claim 1, wherein a threshold NPₜ is defined to limit the number of MPTCP paths for simultaneous data packet scheduling in mesh network topology.
